(19) United States
(12) Patent Application Publication
(10) Pub. No.: US 2024/0211284 A1
(43) Pub. Date: Jun. 27, 2024

(54) FULL LIFE CYCLE DATA SCIENCE ENVIRONMENT GRAPHICAL INTERFACES

(71) Applicant: Raytheon Company, Waltham, MA (US)

(72) Inventors: Travis R. Durbin, PINEHURST, NC (US); Abrielle Otero, Mims, FL (US); Timothy M. Loungeway, GAINSVILLE, VA (US)

(21) Appl. No.: 18/087,270

(22) Filed: Dec. 22, 2022

(51) Int. Cl. G06F 9/451; G06F 3/0482; G06F 16/215

(52) U.S. Cl. CPC G06F 9/453; G06F 3/0482; G06F 16/215

(57) ABSTRACT

Embodiments regard, by a graphical user interface (GUI), for data analytics and machine learning (ML) model project deployment. The method includes providing, on the GUI, a first graphical software control that causes a project creation wizard to be presented on the GUI, providing, on the GUI, a second graphical software control that causes previously generated projects to be presented on the GUI, providing, on the GUI, a third graphical software control that causes previously generated models to be presented on the GUI, and providing, on the GUI, a fourth graphical software control that causes a marketplace of data science projects to be presented on the GUI.

### TECHNICAL FIELD

Embodiments provide a single application and corresponding user interface that helps a user manage all phases of a lifecycle of a data science project.

### BACKGROUND

Data science is the study of data to extract meaningful insights. Data science is a multidisciplinary approach that combines principles and practices from the fields of mathematics, statistics, artificial intelligence, and computer engineering to analyze large amounts of data.

A data science project has a lifecycle that includes determining an objective, data gathering, generating a model, and deploying the model or model output. Each phase of the lifecycle includes interfacing with a different database, software, or the like.

### BRIEF DESCRIPTION OF THE DRAWINGS

FIG. 1 illustrates, by way of example, a diagram of an embodiment of data science project flow.

FIG. 2 illustrates, by way of example, an example home GUI for the data science environment platform.

FIG. 3 illustrates, by way of example, the GUI presented responsive to the user selecting the S.H.I.E.L.D. link in the project list or the watch list of FIG. 2.

FIG. 4 illustrates, by way of example, the GUI displayed responsive to the wizard control of FIG. 2 being selected.

FIG. 5 illustrates, by way of example, the GUI after the continue project control of FIG. 4 is selected.

FIG. 6 illustrates, by way of example, the GUI presented responsive to the user opening a model notebook folder after creating the model in the wizard.

FIG. 7 illustrates, by way of example, a diagram of an embodiment of the GUI presenting the selected notebook from the model notebook folder in FIG. 6.

FIG. 8 illustrates, by way of example, a diagram of an embodiment of the GUI of FIG. 4 after the user selects the control to create a new project.

FIG. 9 illustrates, by way of example, an embodiment of the GUI that is provided responsive to the user selecting a continue button in FIG. 8.

FIG. 10 illustrates, by way of example, a diagram of the GUI provided responsive to the user selecting a continue control on the GUI of FIG. 9.

FIG. 11 illustrates, by way of example, a diagram of the GUI provided responsive to the user selecting the transform data control on the GUI in the state illustrated in FIG. 10.

FIG. 12 illustrates, by way of example, a diagram of the GUI provided responsive to the user selecting the start from scratch control followed by a continue control on the GUI in the state illustrated in FIG. 11.

FIG. 13 illustrates, by way of example, a diagram of the GUI provided responsive to the user selecting the AWS Glue Studio in the GUI of FIG. 12.

FIG. 14 illustrates, by way of example, a diagram of the GUI provided responsive to the user selecting a continue control on the GUI in the state of FIG. 13.

FIG. 15 illustrates, by way of example, a diagram of the GUI provided responsive to the user selecting a notebook type in the GUI of FIG. 14.

FIG. 16 illustrates, by way of example, a diagram of the GUI provided responsive to the user selecting a continue control on the GUI in the state illustrated in FIG. 15.

FIG. 17 illustrates, by way of example, a diagram of the GUI in a state that provides a view of a model database list.

FIG. 18 illustrates, by way of example, a diagram of the GUI of FIG. 17 after a model is ready to be edited.

FIG. 19 illustrates, by way of example a diagram of the GUI in a state after the user has selected an ellipse control on the list.

FIG. 20 illustrates, by way of example, a diagram of the GUI in a state after the user has selected the view metrics control from FIG. 19.

FIG. 21 illustrates, by way of example, a diagram of an embodiment of a state of the GUI after the user selects the show control on the GUI of FIG. 20.

FIG. 22 illustrates, by way of example, a diagram of an embodiment of a state of the GUI after the user selects the edit source code control of FIG. 21.

FIG. 23 illustrates, by way of example, a diagram of the GUI in a state that supports packaging and deploying a widget.

FIG. 24 illustrates, by way of example, a diagram of an embodiment of the GUI in a state for generating a widget.

FIG. 25 illustrates, by way of example, a diagram of an embodiment of the state of the GUI of FIG. 24 after the widget type selected using the control and a model output has been selected using the control on FIG. 24.

FIG. 26 illustrates, by way of example, a diagram of an embodiment of the state of the GUI after the continue control of FIG. 25 is selected.

FIG. 27 illustrates, by way of example, a diagram of the state of the GUI after the user scrolls down on the GUI of FIG. 26.

FIG. 28 illustrates, by way of example, a diagram of the state of the GUI after the user scrolls down on the GUI of FIG. 27.

FIG. 29 illustrates, by way of example, a diagram of the state of the GUI after the user scrolls down on the GUI of FIG. 28.

FIG. 30 illustrates, by way of example, a diagram of the state of the GUI after the user scrolls down on the GUI of FIG. 29.

FIG. 31 illustrates, by way of example, a diagram of a state of the GUI presented responsive to the user selecting a preview button on the GUI of FIG. 30.

FIG. 32 illustrates, by way of example, a diagram of a state of the GUI responsive to a user selecting a caret control proximate a project name.

FIG. 33 illustrates, by way of example, a diagram of a state of the GUI responsive to the user selecting the models tab of the drawer of FIG. 32.

FIG. 34 illustrates, by way of example, a diagram of a state of the GUI responsive to the user selecting the data files tab of the drawer of FIG. 32.

FIG. 35 illustrates, by way of example, a diagram of an embodiment of a system in which the GUI improves data science project interaction.

FIG. 36 illustrates, by way of example, a diagram of an embodiment of a method for improved data science project deployment and management.

FIG. 37 is a block diagram of an example of an environment including a system for neural network training.

FIG. 38 illustrates, by way of example, a block diagram of an embodiment of a machine in the example form of a computer system within which instructions, for causing the machine to perform any one or more of the methods discussed herein, may be executed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Each phase of a data science project lifecycle requires context switching across applications. Experts suggest that each transition from one activity to another costs about 26 minutes of data science expert productivity. Seamless integration of all phases of a data science project lifecycle in a single platform reduces or eliminates the 26 minutes lost from the transition significantly and reduces a total amount of time it takes to move analytic through the data science project lifecycle.

Data acquisition and cleansing consumes a significant amount of time of a data science project. Disparate datasets can be ingested to an integrated data lake. The data lake allows the data scientist to locate and reuse previously ingested and cleansed data thus saving significant time and resources. Embodiments offers integrated cleansing solutions via a modular open systems architecture (MOSA) or a proprietary approach.

Data science projects are often collaborative endeavors. Multiple data science experts are typically involved in a single data science project. There are currently no known data science project solutions that allow for email, chat, text, or other collaboration embedded in the data science project deployment process. Current data science project programs dismiss collaboration around technical processes involving large datasets (e.g., greater than a terabyte (TB)) that are not suitable for transmission by email.

Embodiments include pre-loaded templates that assist with model re-use with a new/current datasets. Models and useful data are hard to find. A data science environment (DSE) of embodiments packages (embedding all elements) and deploys projects, models, widgets, dashboards and data to a self-serve analytics marketplace for use and reuse, as well as other endpoints or environments.

The DSE of embodiments integrates all phases of the data science project lifecycle into a series of graphical user interfaces (GUIs) that are presented by a single software application. The GUI provides a data scientist, whether experienced or more junior, a simple series of graphics that guide the data scientist through project setup, configuration, and deployment. The GUI encourages best practices for data science project implementation and deployment. The GUI encourages collaboration between data scientist experts. The GUI reduces an amount of time from project conception to deployment by reducing time spent gather data, cleaning data, choosing a model type, generating a model, populating/training the model, generating a final product, deploying the final product to a marketplace, or the like.

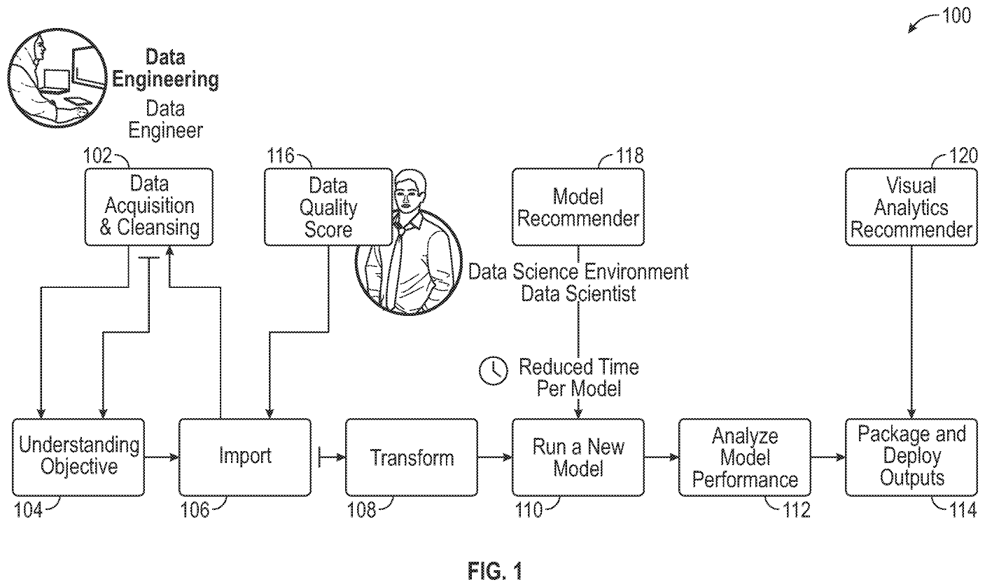

FIG. 1 illustrates, by way of example, a diagram of an embodiment of data science project flow 100. The flow 100 as illustrated includes data acquisition and cleansing, at operation 102; defining an objective of the data science project, at operation 104; importing the cleaned data, at operation 106; transforming the imported data to features, at operation 108; generating a model, at operation 110; analyzing model performance, at operation 112; and packaging deploying the model, outputs, or a combination thereof, at operation 114.

The operation 102 includes gathering all the raw data for the data science project into a single location. The data can, instead of being raw, be represented by a link to the data. The data can be from a public repository, a private repository, a combination thereof, or the like. The operation 102 can include cleaning the gathered data. Cleaning data is distinct from data transformation. Data transformation alters one or more values of the data itself. Cleaning data fixes or removes incorrect, corrupted, duplicated, or incomplete data. Data transformation is the process of converting data from one format or structure into another. Transformation processes can also be referred to as data wrangling, or data munging, transforming and mapping data from one “raw” data form into another format for warehousing and analyzing. When combining multiple data sources, there are many opportunities for data to be duplicated or mislabeled. If data is incorrect, outcomes and algorithms are unreliable, even though they may look correct. There is no one absolute way to prescribe the exact steps in the data cleaning process because the processes will vary from dataset to dataset.

Removing unwanted observations from a dataset, including duplicate observations or irrelevant observations can be performed at operation 102. Duplicate observations will happen most often during data collection. When combining data sets from multiple places, such as scraped data, or received data from clients or multiple departments, there are opportunities to create duplicate data.

Irrelevant observations can be removed at operation 102. Irrelevant observations are observations that do not fit into the specific objective of the data science project. For example, if data regarding millennial customers is desired, and the dataset includes older generations, those observations of the older generations are irrelevant. Removing irrelevant observations makes analysis more efficient and minimizes distraction from the primary target-as well as creating a more manageable and more performant dataset.

Structural errors can occur when measuring or transferring data. Structural errors include different naming conventions, typos, incorrect capitalization, or the like. These inconsistencies can cause mislabeled categories or classes. For example, one dataset can include “N/A” and another dataset can include “Not Applicable”, but they should be analyzed as the same category. The operation 102 can make the naming conventions consistent so as to be analyzed under the same category.

Often, there will be observations that do not fit within the data being analyzed. If there is a legitimate reason to remove an outlier, like improper data-entry, doing so will help the performance of the data and the corresponding model. However, sometimes it is the appearance of an outlier that will prove a theory. Remember: just because an outlier exists, does not mean it is incorrect. This step is needed to determine the validity of that number. If an outlier proves to be irrelevant for analysis or is a mistake, it can be removed at operation 102.

Missing data is where an entry or an entire observation is missing. Sometimes missing data cannot be ignored because many algorithms will not accept missing values. There are a couple of ways to deal with missing data. As a first option, observations that have missing values can be dropped, but doing this will drop or lose information. As a second option, missing values can be provided based on other observations. There is an opportunity to lose integrity of the data because assumptions and not actual observations can be bad assumptions. As a third option, the way the data is used can be altered to effectively navigate null values. The operation 102 can include handling missing data in any of these ways.

An example software that cleans data is Amazon Web Services & Glue Studio® of Seattle, Washington, United States of America (USA). The operation 102 can include a GUI that interfaces, such as through an application programming interface (API), with Glue Studio® so that Glue Studio® can perform the data cleaning operations 102. In some instances, a model that cleans data can be created using the GUI 200, hosted by infrastructure supporting the GUI 200, or a combination thereof. The model can then be used to cleanse data, such as from a standard formatted file.

The operation 104 can include putting the goal of the data science project into words. Metes and bounds of the data science project can be defined at operation 104. The objective captures the purpose of the data science project. The objective can be a sentence, paragraph, or the like. The objective can include limits on the data to be included, a model to be used, a final product to be provided, a combination thereof, or the like. The objective can be to build on a prior project, start a new project, or the like.

of different locations, rather than gathering the data into a single location. Gathering the data into the single location can include The operation 106 can include importing cleaned data into a single data lake. While such an operation may seem trivial, this is not a common operation performed in current data science projects. Data science projects commonly operate on data from a variety providing links to the data, storing the raw data, a compressed form of the raw data, a combination thereof, or the like. The GUI can allow the user access same access to the data regardless of the form it stored in the data lake. That is, the user does not know whether there is a link to the data, raw data, or that the data is in any particular format as all of this is hid and handled by the GUI. Such a GUI makes the user interface easier for the user, as the user does not need to manage separate tabs of a browser, application interfaces, or the like. Examples of data lakes includes Amazon Web Services & Simple Storage Service (Amazon S3)® from Amazon Incorporated of Seattle, WA, USA, Amazon RedShift® from Amazon Incorporated, and Amazon Athena® from Amazon Incorporated, among others, are example services for creating and maintaining a data lake. Note the imported data can be in a variety of formats, such as comma separated value (CSV), portable data format (PDF), Excel, java script object notation (JSON), keyhole markup language (KML), open cybersecurity schema framework (OCSF), or a proprietary format or database.

A data quality operator 116 can determine a quality score for the data in the data lake. The data quality score can indicate how likely the data in the data lake, when used, will generate a reliable result. The data quality score can be determined based on completeness (% total of non-nulls and non-blanks), uniqueness (% of non-duplicate values), consistency (% of data having patterns), validity (% of reference matching), accuracy (% of unaltered values), linkage (% of well-integrated data), a combination thereof, or the like.

The transform operation 108 determines features of the data imported at operation 106 or otherwise in the data lake. Features are aspects of the data that are relevant to a given model. Features can be generated by a machine learning (ML) model or generated based on a heuristic. Learning the features can include training an embedding layer and then inputting the data from the data lake into the embedding layer. A heuristic can include a statistic (e.g., average (e.g., mean, median, mode, or the like), standard deviation, whether the data is above or below a specified value, a percentile, an expected value, variance, covariance, among many others) or a series of mathematical operations performed on the data. An example application that performs operation 108 is Amazon Web Services Glue Studios from Amazon Incorporated.

At operation 110, a user can select a model type of a model to generate from scratch, a model template of a model that was previously generated, a model that was previously generated, or the like. The model type can be on an application level or a more granular level. The model types can include data analytics or machine learning models. The data analytics models can be descriptive, predictive, prescriptive, or diagnostic. Assessment, tracking, comparing, and reporting are all example operations performed by a descriptive model. Prediction, root cause, data mining, forecasting, Monte-Carlo simulating, and pattern of life are all example operations performed by a predictive model. Prescriptive models perform optimization. Diagnostic models determine likelihoods, probabilities, or distribution outcomes. ML model types can be reinforcement learning (RL), supervised, unsupervised, or semi-supervised. Example RL model operations includes real-time decisions, game artificial intelligence (AI), learning tasks, skill acquisition, robot navigation, or the like. The supervised type can perform classification or regression. Classification can include detecting fraud, performing image classification, customer retention, diagnostics, or the like. Regression can provide new insights, forecasting, predictions, process optimization, or the like. Unsupervised learning can include clustering or dimensionality reduction. Clustering can be used for providing a recommendation, targeting, segmentation, or the like. Dimensionality reduction can be used for providing a big data visual, compression, structure discovery, feature elicitation, or the like.

There are many model generation applications to which the GUI can interface. Examples of such applications include Amazon Web Services & Sagemaker® from Amazon Incorporated, Jupyter Notebook from Jupyter Project (an open-source endeavor), and Zeppelin from the Apache Software Foundation, among others.

The operation 110 can further include training or otherwise setting parameters of the selected model. Training the model can include supervised or semi-supervised learning based on training sample (e.g., input, output samples) in the data lake. The training data can be a subset of the data. The data lake can further include testing data for performing operation 112. Setting parameters can include setting hyperparameters (e.g., number of layers, types of layers, order of layers, number of neurons, gradient step size, number of samples in a batch, number of batches, activation functions, cost function, or the like) or model parameters (e.g., weights, bias, or the like), or the like.

A template recommender 118 can recommend a new model type, a template, an existing model, or other model to the user through the GUI. The template recommender 118 can include an ML model that is trained to provide the template recommendation. The template recommender 116 can receive the objective defined at operation 104, a project description, or other text describing the purpose of the data science project as input. The template recommender 116 can perform a semantic comparison of the input to other text descriptions of data science projects. The template recommender 118 can return an output that is a model, model type, or template that was used in the data science project that is most semantically similar to the data science project being created.

The operation 112 includes testing the generated model and monitoring model performance over time. The operation 112 can include detecting model drift and alerting if drift has occurred, a class that is causing the drift, or the like. The operation 112 can provide a visual depiction of model performance, such as an ROC curve, training accuracy, output and confidence of output, among other performance metrics. Performance metrics will vary by model types. For example a data analytics model has different performance metrics than M. Also, performance metrics for the sub type of the model can indicate different performance metrics. For example, performance metrics are different for regression and classification models. The GUI 200 accounts for these nuances.

The operation 114 includes preparing and published the model generated or selected at operation 110 for use by other data scientists or analysts. The operation 114 includes selecting a tool to visualize results produced by the model generated at operation 110. The tool can be, for example, Kibana, which is an open source data visualization tool that generates pie charts, bar graphs, heat maps or the like, Tableau, which has an extensive online community portal of open-source data, dashboards, infographics and plots that allows users to create reports and publish to the Tableau public portal, and CloudWatch from Amazon Incorporated, which is a cloud monitoring tool that collects and tracks metrics on operating cloud resources, such as Amazon Web Services that the user uses. CloudWatch allows a user to create custom dashboards, applications, and metrics.

A visual analytics recommender 120 can recommend an analytics to the user through the GUI. The visual analytics recommender 120 can include an ML model that is trained to provide the template recommendation. The visual analytics recommender 116 can receive the structure or features of the data used to generate the model, data to be input to the model, objective defined at operation 104, a project description, or other text describing the purpose of the data science project as input. The visual analytics recommender 116 can perform a semantic comparison of the input to other text descriptions of data science projects. The visual analytics recommender 120 can return an output that is a visual analytics tool, graphic type, or other visual object type that was used in the data science project that is most semantically similar to the data science project being created.

The data science environment provided by the flow 100 provides a robust pipeline that optimizes the creation of models in a collaborative environment. Data engineers and scientists can tackle the toughest of data science challenges in a single integrated-open platform. Objective, model, and data type aside, data and models may be synthesized into powerful visualizations at enterprise scale. The open platform allows users to assemble models with a variety of data sources while creating a single source of truth for data storage without displacing or disrupting existing data, tools or processes.

Models can be reused in the form of pre-loaded templates. All data science assets can be taken through a facilitated package and deploy process where models are paired with visual analytics to form widgets, then published to a private analytics marketplace, or analogous environment. The flow 100 can include monitoring to track model accuracy and drift. The flow 100 can include embedded algorithms (e.g., data quality score operator, template recommender, visual analytic recommender) to support decision making across the user journey: Data quality score (Cleanliness, completeness, objective and model type); Template recommender (model templates with explainable AI); Visual analytic recommender (The right visual for the objective and dataset).

Embodiments provide advantages and improvements in terms of data science project lifecycle through an open platform (MOSA) that can be accessed through a cloud or a more local network. Embodiments provide model templates that can be accessed from a variety of tools. Embodiments allow for controlled data scientist collaboration through an entire data science project lifestyle. Embodiment allow the data scientist to create projects to organize a team and collaborate with teammates throughout the lifecycle for all resources; data, models, projects, products and dashboards.

Embodiments seamlessly provide for project packaging or model packaging, such as for easy reuse. Embodiments pair models with advance visual analytics so that a user can view model performance metrics seamlessly. Embodiments provide for deployment of a variety of resources to a variety of environments across an enterprise. Embodiments provide for monitoring of model performance, such as accuracy and drift. Embodiments support decision making throughout the project lifecycle by providing best-practice recommendations that support decision making across the user journey, such as providing a data quality score and explanation based on data cleanliness, completeness, objective, and model type); a template recommender (model templates with explainable artificial intelligence (AI)); or a visual analytic recommender (the right visual for the dataset and objective).

To the best of the inventors' knowledge, there is no single platform that provides all of the following features: an open framework, project management, pre-loaded model templates, collaboration through the project lifecycle, automated (or at least semi-automated) data acquisition and cleansing, data modeling, model performance monitoring, and packaging and deploying the model as a product.

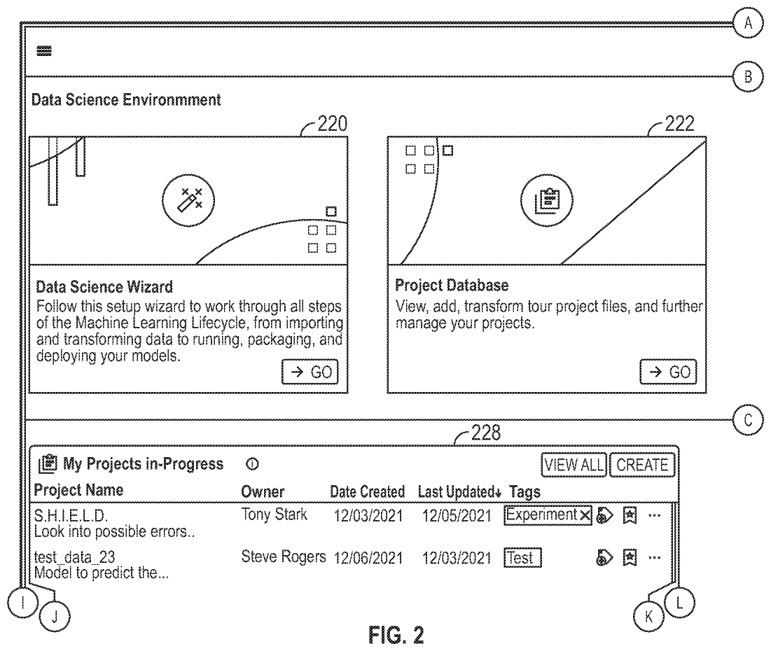

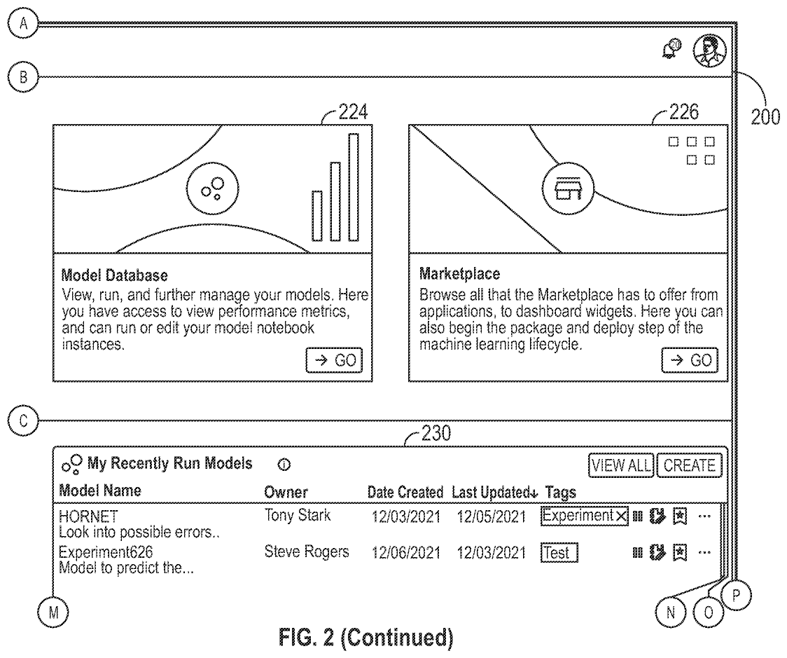

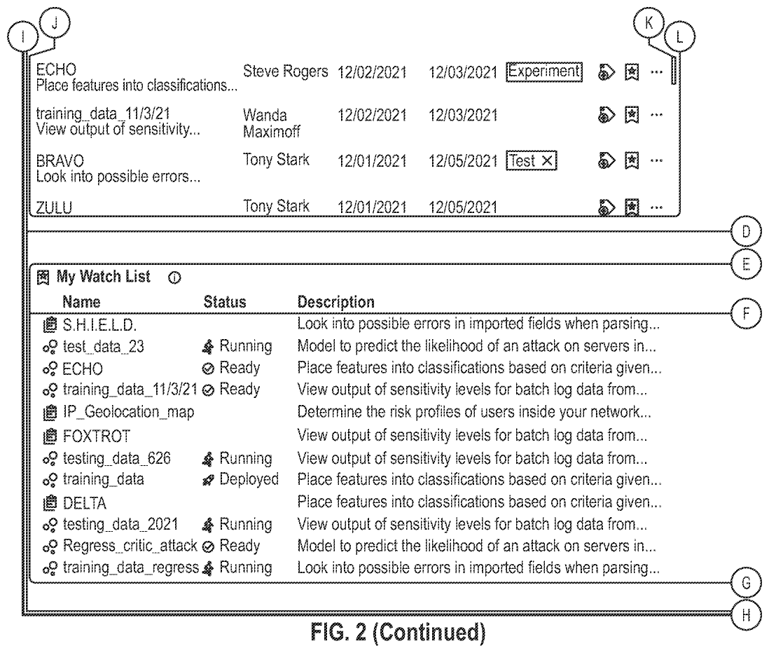

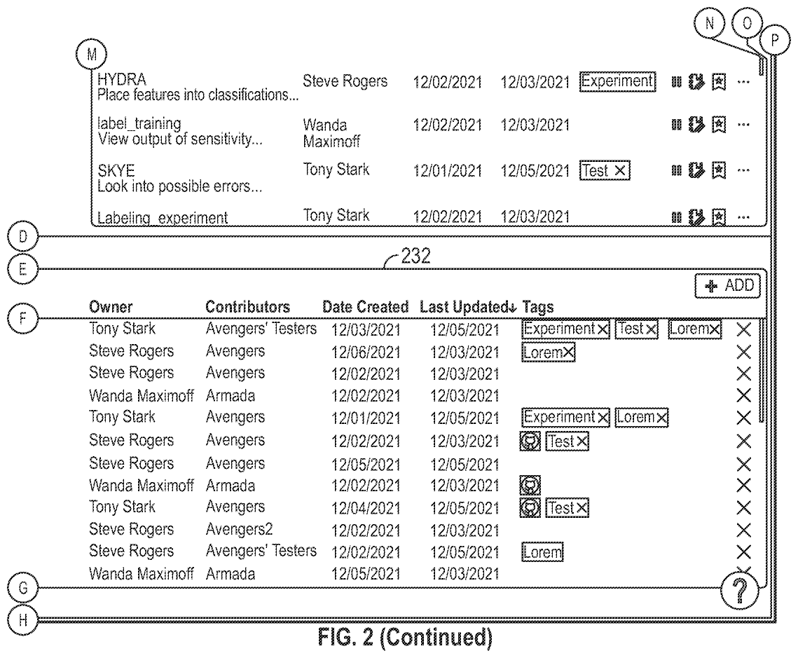

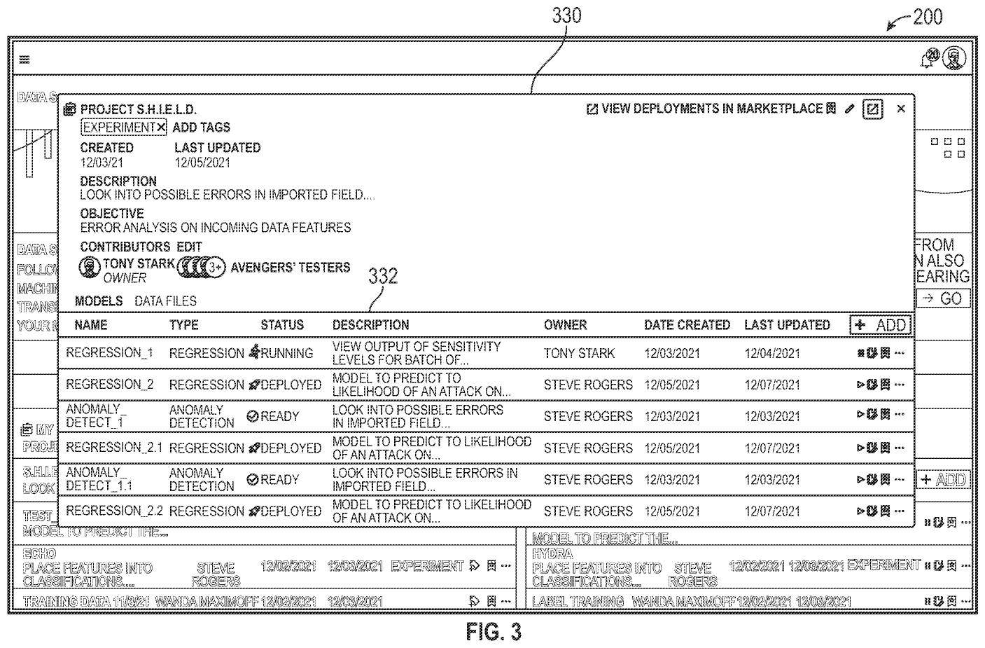

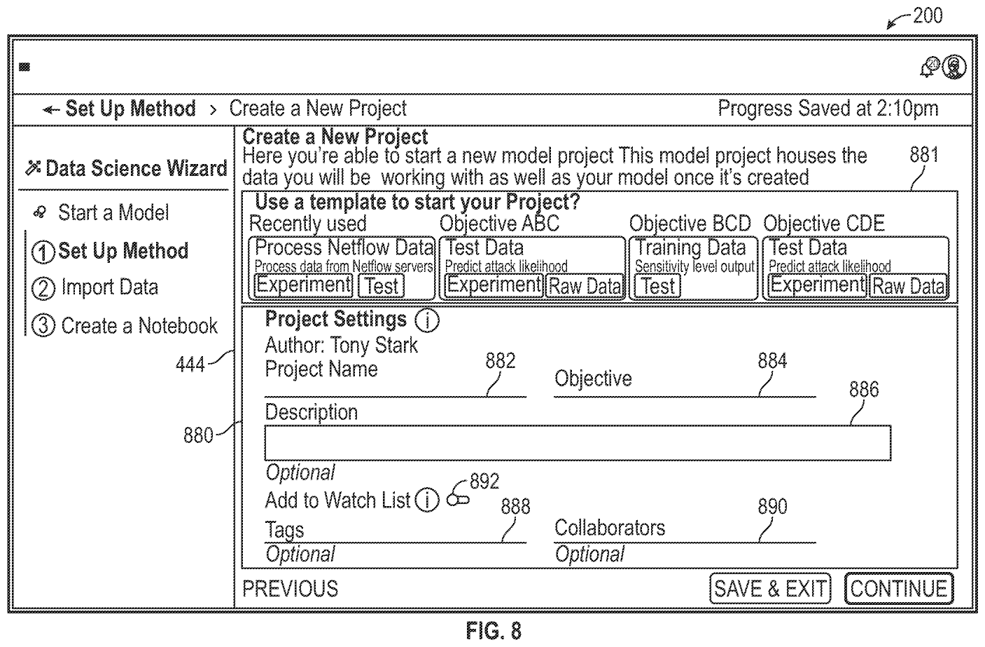

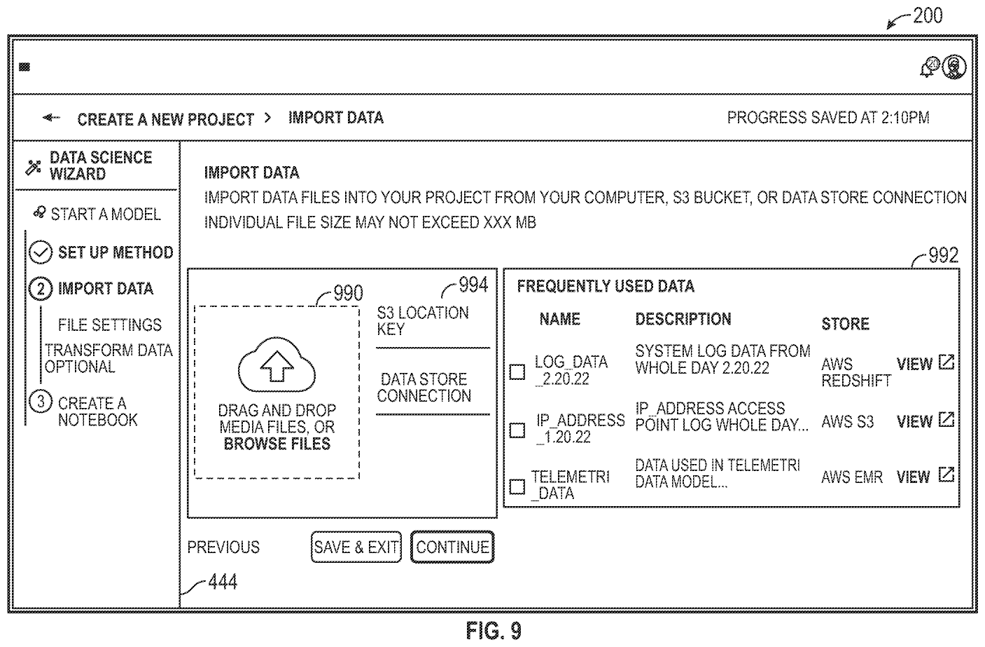

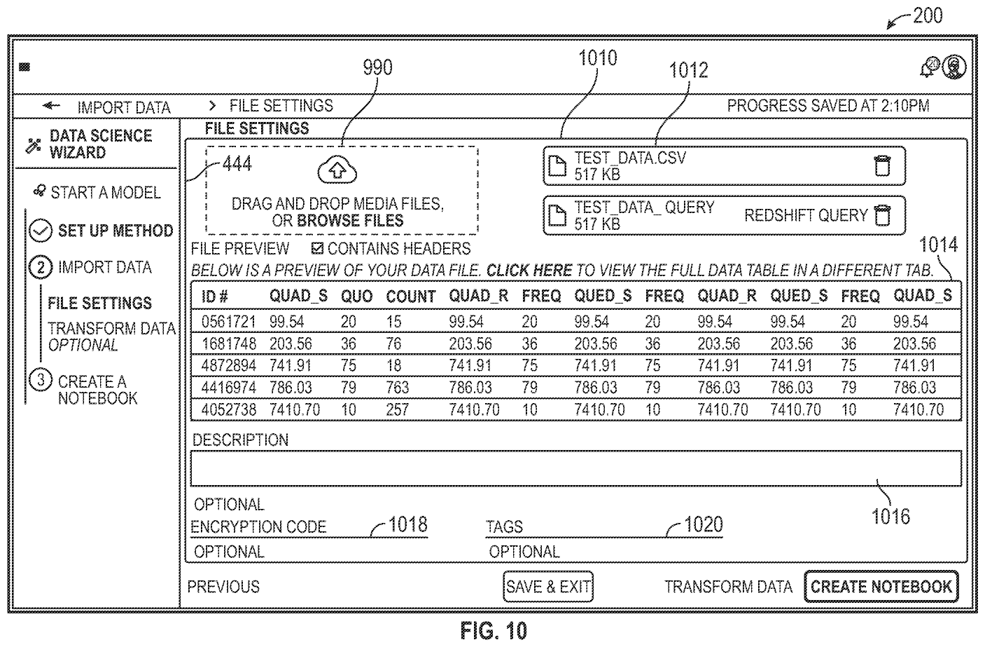

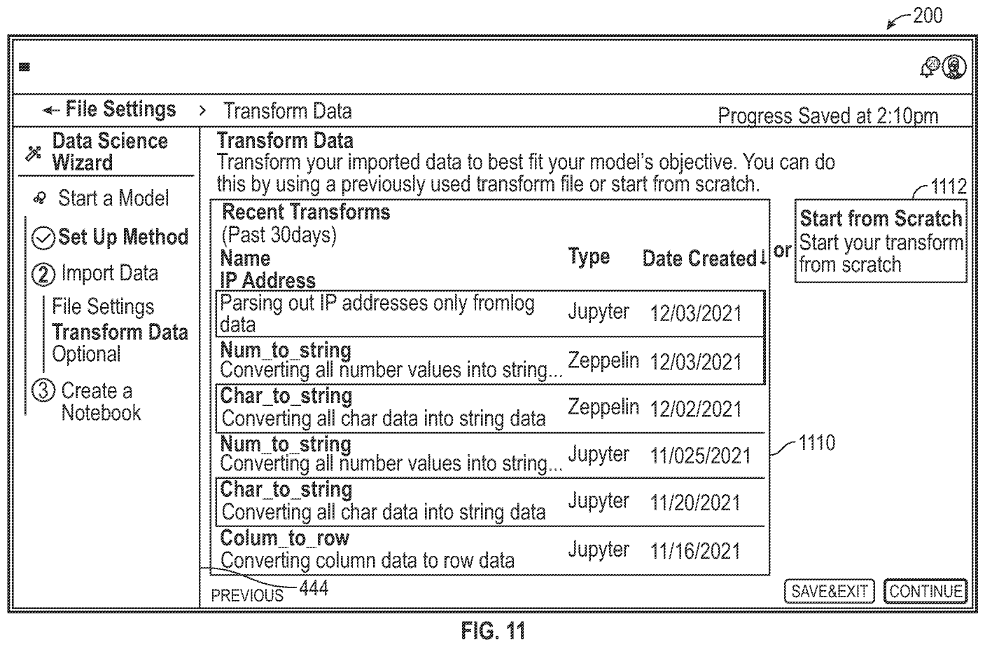

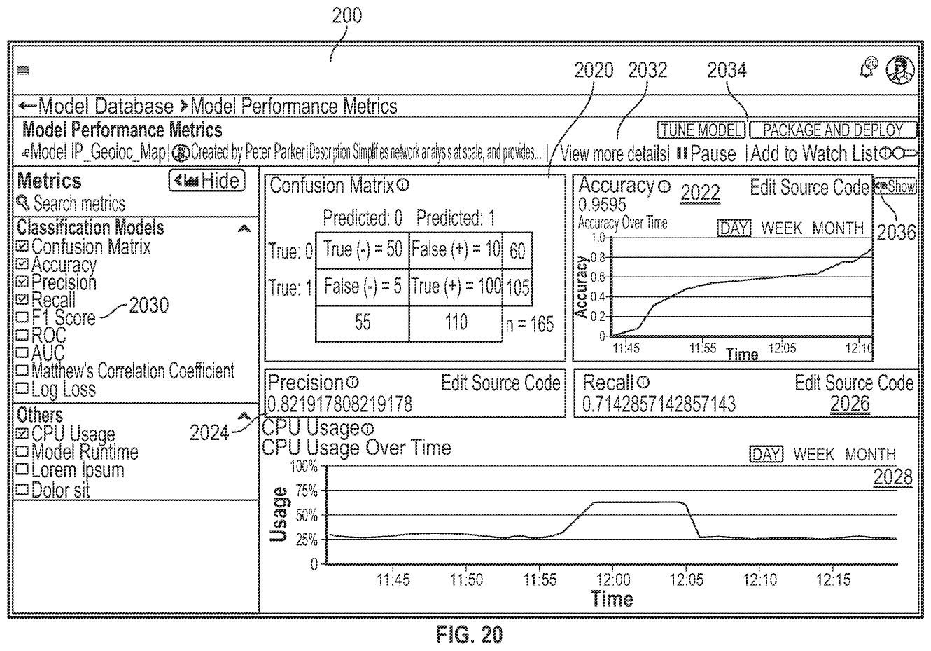

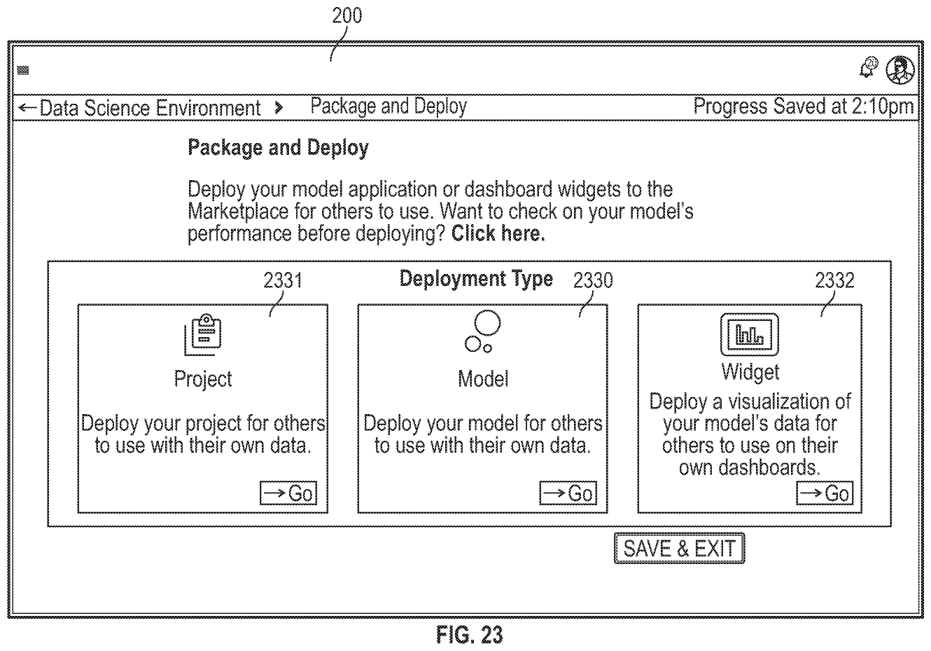

FIGS. 2-48 illustrate, by way of example, different states of a GUI that provides an all-in-one, end-to-end data science project creation, collaboration, and management platform. The GUI 200 in the states illustrated in FIGS. 9-10 support the operations 102 and 106 (data acquisition, cleansing, and import). The GUI 200 in the states illustrated in FIGS. 11-13 support the operations 102 and 108 (data acquisition, cleansing, and transformation). The GUI 200 in the state illustrated in FIG. 8 supports the operation 104 (understanding objective). The GUI 200 in the states illustrated in FIGS. 3, 5-8, 14-19, 32-34 support the operation 110 (run a model). The GUI 200 in the states illustrated in FIGS. 20-22, 41 support the operation 112 (analyze model performance). The GUI 200 in the states illustrated in FIGS. 23-31, 35-48 support the operation 114 (package and deploy)

FIG. 2 illustrates, by way of example, an example home GUI 200 for the data science environment platform. The GUI 200 as illustrated includes a variety of graphical software controls 220, 222, 224, 226, and lists 228, 230, 232 with hyperlinks. While a particular software control or list is illustrated as including a particular graphic and textual details with a particular size and at a particular location, a different graphic, details, size, location, or a combination thereof are all possible and within the scope of embodiments. Further, while a particular type of software control is illustrated, other types of software controls can be substituted for a given software control without straying from the scope of embodiments.

A graphical software control is a software element that is displayed on a graphical user interface and with which a user can interact. The interaction can include providing input, selecting, a combination thereof, or the like. Example software control types include radio buttons, checklists, buttons, drop-down menus, sticky menu, scroll panel, cards, tables, chips/badges, icons, links, checkboxes, toggle switches, segmented controls, input boxes, a combination thereof, or the like. A graphical software control, when interacted with, executes a function associated with the graphical software control.

The control 220, when selected, launches a wizard through which a user can work through the whole lifecycle of a data science project. More details of the wizard are provided elsewhere. A wizard or setup assistant is a user interface that presents a series of dialog boxes to lead the user through a sequence of smaller steps that achieve a larger objective. The control 220 can be selected by a user that is looking to setup a project that does not yet exist.

The control 222, when selected, presents a user with a view of projects that have been started previously, such as through the wizard provided responsive to the control 220 being selected. The projects can be in process, completed, or the like. The projects displayed to the user can be limited to projects for which the user that is logged into the data science environment has been assigned a role. The projects displayed can be displayed in a rank order. The rank can be determined based on date/time created, date/time last accessed, amount of time personnel are spending on the project, a combination thereof, or the like.

The control 224, when selected, presents a user with a view of models that have been started previously, such as through the wizard provided responsive to the control 220 being selected. The models can be in process, completed, or the like. The models presented can be any and all public models or models for which the user has been assigned a role. The models displayed can be displayed in a rank order. The rank can be determined based on date/time created, date/time last accessed, amount of time personnel are spending on the model, a number of times the model has been deployed, an accuracy of the model, a combination thereof, or the like.

The control 226, when selected presents a user with a view of deployed products that are available for use. The products are widgets that are a combination of analytics (data analysis results) and a model. The widgets allow a user to enter new data into the model to return a result, explore other results provided by the model, present the data in a graphically meaningful manner, or the like. There are many combinations of models and relevant graphics, too many to list here.

The list 228 details projects for which the user has a role. The list 228 includes links that, when selected, cause the GUI to display a home page for the selected project. The list includes a snippet of an objective or description of each project (e.g., directly underneath the link to the project). The link can include text that is the name of the project. The list 228 includes further details of the projects in the list including an owner name, a date the project was created, a date the project was last updated, tags associated with the project, among other. The list 228 includes a software control through which the user can add a project to the list 228.

The list 230 details models that the user has executed. The list 230 includes links that, when selected, cause the GUI to display a home page for the selected model. The list 230 includes a snippet of an objective or description of each project (e.g., directly underneath the link to the model) for which the model is a part. The link can include text that is the name of the model. The list 230 includes further details of the models in the list including an owner name, a date the model was created, a date the model was last updated, tags associated with the model, among others. The list 230 includes a software control through which the user can add a model to the list 230.

The list 232 provides a view of some projects for which the user would like to stay up-to-date on progress. The list 232 is similar to the list 228, with the list including more details regarding each of the projects enumerated in the list 232. The details provided in the list include the project name (presented as a selectable link that, when selected provides the project homepage on the GUI, a status of the project (e.g., running, ready for deployment, deployed, or the like), a more detailed description of the project than what is provided on the list 228, an owner of the project, contributors to the project, a date the project was created, a date the project was last updated, and tags associated with the project.

FIG. 3 illustrates, by way of example, the GUI 200 presented responsive to the user selecting the S.H.I.E.L.D. link in the project list 228 or the watch list 232. The GUI 200 provides a popup 330 that is displayed over a portion of the display shown in FIG. 2. The popup 330 illustrates more details of the project than what is provided in the watch list 232. The details provided in the popup 330 include the details of provided in the watch list 232 as well as more details. The popup 330 as illustrated includes another list that includes selectable tabs. The selectable tabs include a models tab and a data files tab. The models tab, when selected provides details of the model associated with the project including a name of the model, a type of the model (e.g., regression, neural network, anomaly detection, or the like), the status of the model, a description of the model function, an owner of the project, a date the project was created, a date the project was updated, among others. The data files tab, when selected provides a user with a view of the data sources used to generate the model, test the model, or a combination thereof.

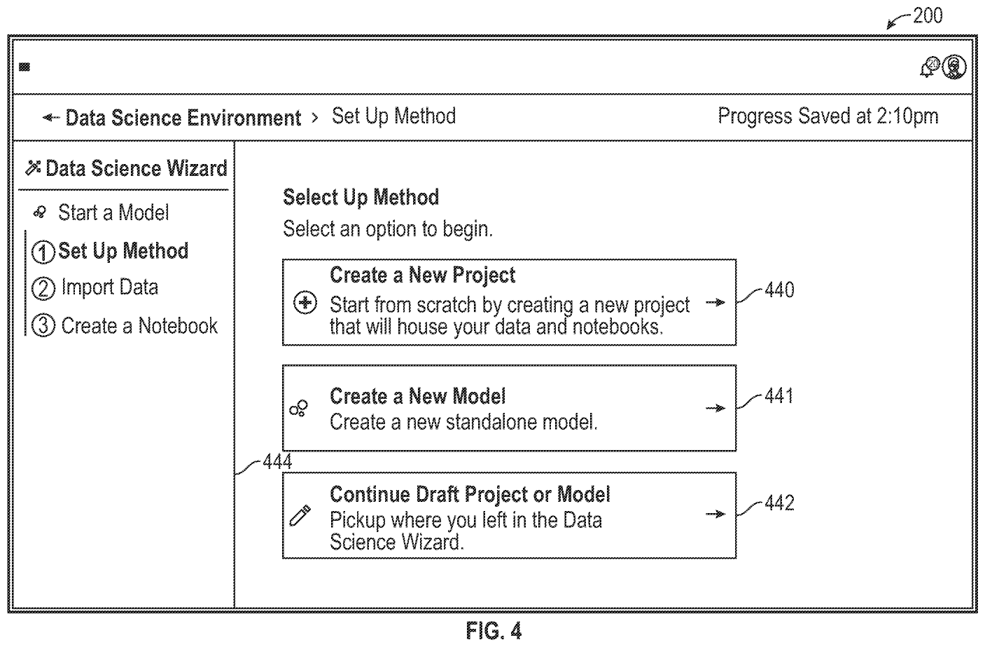

FIG. 4 illustrates, by way of example, the GUI 200 displayed responsive to the wizard control 220 being selected. On the left of the GUI 200 is a stepper graphic 444 that shows which step the user is currently at in the wizard. Using the GUI 200 the user has access to all header navigation like on the previous Data Science Environment landing page illustrated in FIG. 2. This data is currently on the “Set Up Method” link, signified by the blue text on the stepper as well as the content in the center of the page. There are three set up method options illustrated: creating a new project through software control 440, creating a new model through software control 441, and continuing a pre-existing project using the software control 442. In the header of the GUI 200, there are breadcrumbs (e.g., also on all of the pages of the wizard) in case the user wishes to go back at any point. Using the GUI 200 of FIG. 4, the user is able to choose to begin by creating a new project or continuing a previously created project (e.g., a project created previously by the user or a project for which the user is listed as the owner).

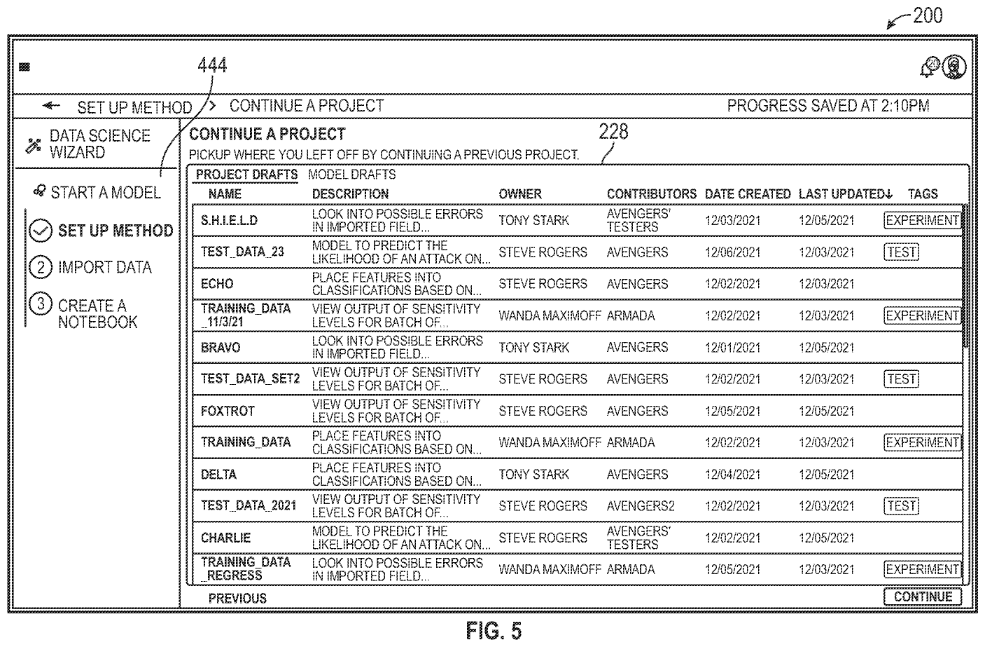

FIG. 5 illustrates, by way of example, the GUI 200 after the continue project control 442 of FIG. 4 is selected. The GUI 200 presents the list 228 responsive to the user selecting the control 442. Note, the GUI 200 of FIG. 5, the stepper 444 does not change state response to the user selecting the control 442. Using the GUI 200 of FIG. 5, the user can select the project from the enumerated projects provided in the list 228. The list 228 shows pertinent details about the project such as Name, description, author, team, date created, last updated, and any tags associated with it. Responsive to selecting a project from the list 228 the Wizard causes a next step to be displayed on the GUI 200. Note that progress through the wizard can be automatically saved as the user progresses through the wizard, as signified by the message at the top right corner of the GUI 200 of FIG. 5.

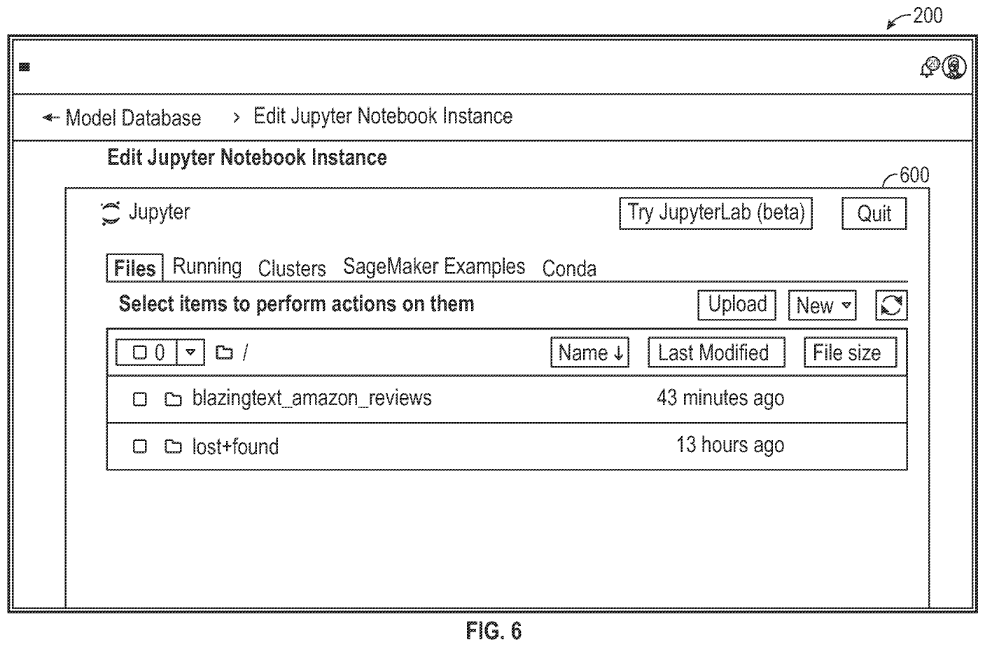

FIG. 6 illustrates, by way of example, the GUI 200 presented responsive to the user selecting a project from the project list 228. The project illustrated is a Jupyter project, but other project types are within the scope of embodiments. A project home screen including a project home page control 660 is provided in FIG. 6. The home screen control 660 includes a variety of tabs and folders. The illustrated tabs includes the illustrated files tab that provides a delineated list of folders and files associated with the project. Other tabs include a running tab, clusters tab, an examples tab, and a package deployment tab (labelled “Conda” in FIG. 6. The GUI 200 of FIG. 6 is the console for the project. New notebooks, files, or others can be added using the console.

After selecting the model, file, or notebook desired, the GUI 200 presents an interface to interact with the selected item. In the example of FIG. 6, the user can select the notebook and be presented with the selected notebook.

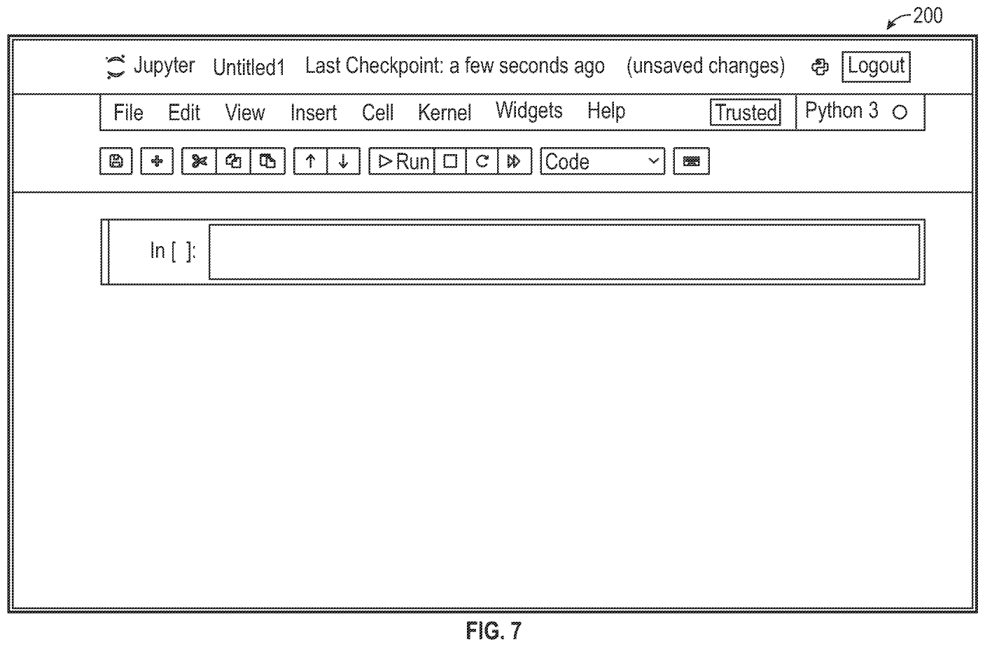

FIG. 7 illustrates, by way of example, a diagram of an embodiment of the GUI 200 presenting the selected notebook from the files tab in FIG. 6. The user can actively edit the notebook without having to switch to a different application, login to a different platform, or a combination thereof. Using the GUI 200 of FIG. 7, the user can add code to, or otherwise edit the selected notebook.

FIG. 8 illustrates, by way of example, a diagram of an embodiment of the GUI 200 of FIG. 4 after the user selects the control 440. The GUI 200 of FIG. 8 is presented as part of the operation 104. The GUI 200 provides a new project interface 880 that includes some input controls 882, 884, 886, drop down menus 888, 890, the stepper 444, and a binary control 892. The GUI 200 also presents the user with some templates in software control 881. The templates in the software control 881 can be organized by most recent, most relevant (highest recommended), most used, best reviews, a different organization, or the like. The templates in the software control 881 can be selected to add the template to the current project and provide the user with a baseline or shell to fill in and expedite completion of the project or model. Note that the stepper 444 has not been altered responsive to the user selecting the control 440. The user can enter a project name in the name control 882. The name is illustrated as the main delineator in the lists 228, 232. The user enters text into the objective control 884. The text indicates the purpose or goal of the project associated with the project name 882 entered into the name control 882. The user enters further text into the description control 886. The text in the description control 886 is a more detailed breakdown of the how the project is going to achieve the objective described in the objective control 884.

The tags dropdown menu 888 allows the user to associate keywords with the project. The tags can include common catchphrases, jargon, or the like that describes the type of project at a high level. Example tags include “experiment”, “Lorem”, “test”, among many others. The collaborators dropdown menu 890 allows the user to select who is going to work on the project and under what respective capacities those people are going to work. The add to watch list binary control 892, when slid to the right, indicates that the project is to be present on the watch list 232.

All of the text entered in the controls 882, 884, 886 and tags selected using the tags dropdown menu 888 is searchable and can be used to provide a recommendation to the user later in the project creation process. The text and tags can form a string, description, or other representation of the semantics of the project.

FIG. 9 illustrates, by way of example, an embodiment of the GUI 200 that is provided responsive to the user selecting a continue button on the GUI 200 in FIG. 8. The GUI 200 of FIG. 9 is presented as part of the operation 102. A dropbox control 990, a frequently used data list 992, and an external data import control 994 are provided in the example of FIG. 9. The dropbox control 990 allows a user to drag and drop data that is local to the user. The external data import control 994 allows the user to define a link to data that is remote to the user and relevant to the project. The user can enter a URL, username, password, or other authentication information required for accessing the external data into the control 994. The frequently used data list 992 includes radio boxes that, when selected, add the corresponding data to the project. The stepper in FIG. 9 has advance to an import data state. Also, the transport data state has expanded to show additional substeps within the import data state.

FIG. 10 illustrates, by way of example, a diagram of the GUI 200 provided responsive to the user selecting a continue control on the GUI of FIG. 9. The GUI 200 of FIG. 10 includes a file settings display 1010. The display 1010 includes the drag and drop control 990, a view of at least some of the files 1012 added to the project, a list 1014 of some sample data from the files 1012. The display 1010 further includes a description control 1016 into which the user can provide a textual description of the data in the project. The description can describe features of the data, parameters of the data, or other qualities of the data. Features are individual measurable properties or characteristics of the data. Parameters are metadata of the data, such as range, size, or the like

The encryption code input control 1018 allows a user to specify a decryption key for the data. The data can be stored in encrypted form and decrypted using the decryption key. The tags control 1020 allows the user to select tags associated with the data. The text from the description control 1016 and the tags from the tags control 1020 can additionally be used along with the other description, tags, or a combination thereof to provide a recommendation to a user.

FIG. 11 illustrates, by way of example, a diagram of the GUI 200 provided responsive to the user selecting a continue control on the GUI 200 in the state illustrated in FIG. 10. The GUI 200 of FIG. 11 is presented as part of the operation 108 of FIG. 1. The GUI 200 of FIG. 11 includes a recent transforms list 1110, and a start from scratch control 1112. The list 1110 includes operations that have been used on a prior data science project or were pre-loaded into the data science environment. Responsive to selecting the control 1112, a user can define a transformation that is not on the list 1110. The newly defined transformation can then be added to the list 1110. The stepper 444 in the GUI 200 of FIG. 11 is in a new state to indicate that the user in the “transform data” step in the import data operations.

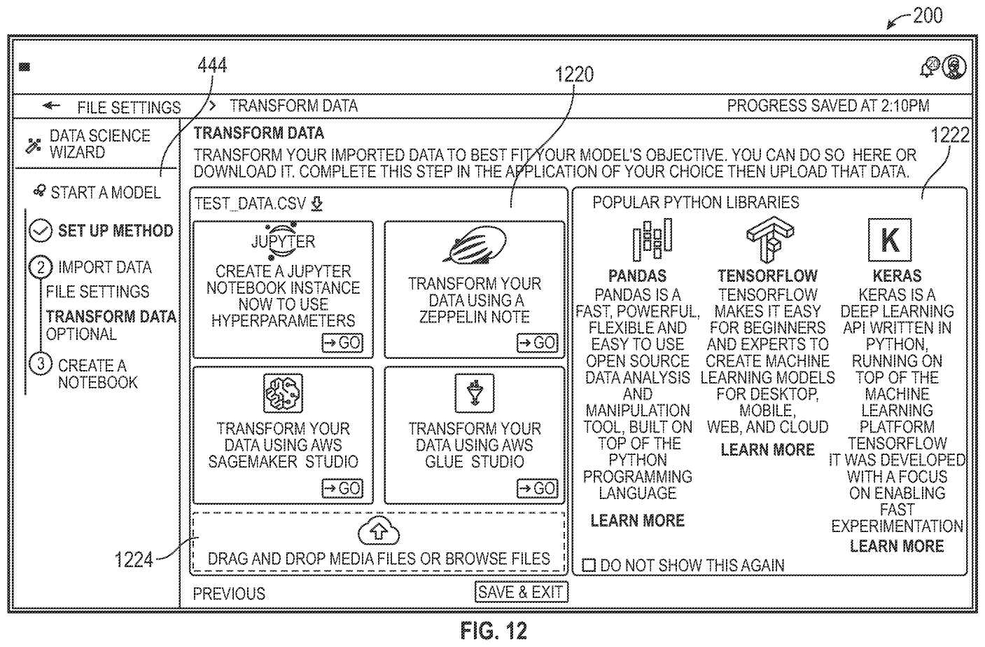

FIG. 12 illustrates, by way of example, a diagram of the GUI 200 provided responsive to the user selecting the start from scratch control 1112 followed by a continue control on the GUI 200 in the state illustrated in FIG. 11. The GUI 200 of FIG. 12 presents the user with links to processes for transforming the data. The processes are presented in lists 1220 and 1222. Responsive to the user selecting a process in one of the lists 1220, 1222, the user will be presented with the functionality of the selected process so the user can define the transformation. A drag and drop control 1223 allows the user to generate the transformed data outside of the environment and then upload the data to by dropping it in the control 1223. The stepper 444 in FIG. 12 has not changed state from FIG. 11.

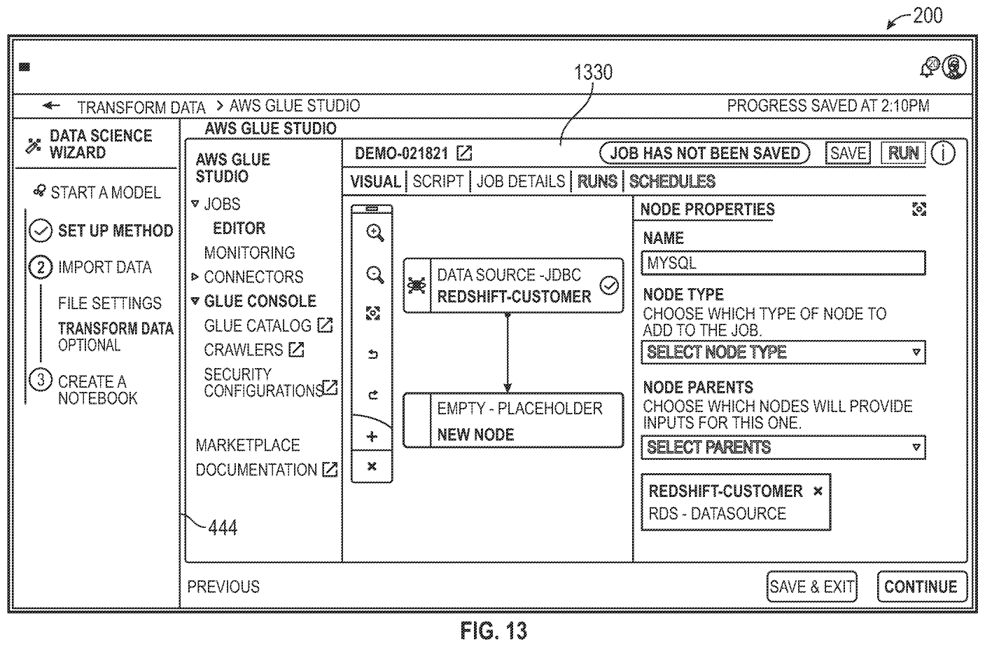

FIG. 13 illustrates, by way of example, a diagram of the GUI 200 provided responsive to the user selecting the AWS Glue Studio in the GUI 200 of FIG. 12. The user can define their transformation using a process interface 1330 provided through the GUI 200 in FIG. 13. Note that different process interfaces are presented for different process selections in FIG. 12. The stepper 444 has not changed state as the user is still in the transform data process. After the user configures their data, they are then guided through a model creation process.

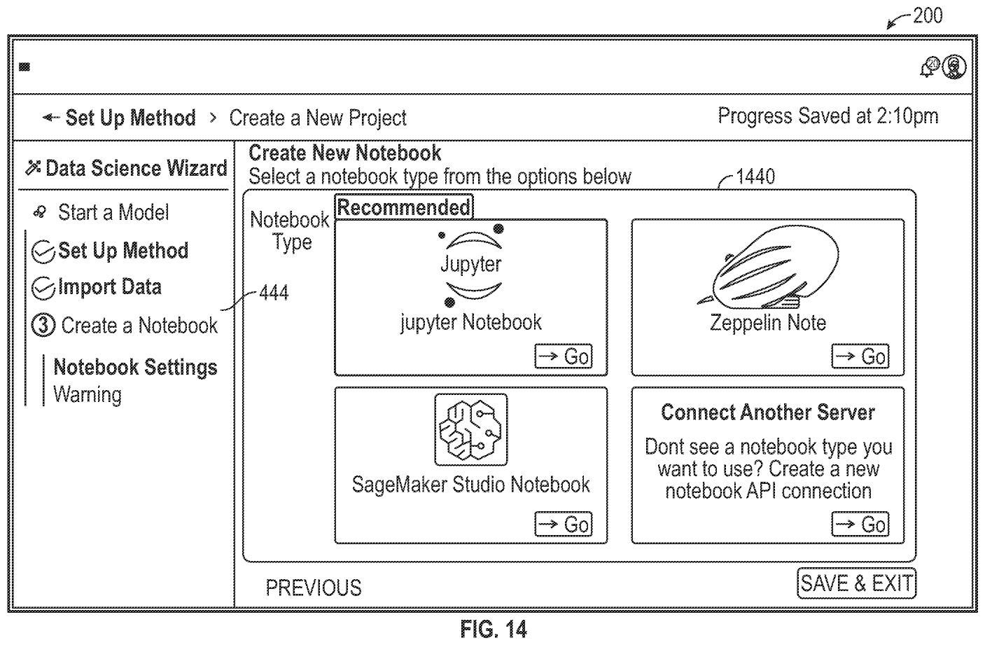

FIG. 14 illustrates, by way of example, a diagram of the GUI 200 provided responsive to the user selecting a save and exit control on the GUI 200 in the state of FIG. 12. Using the GUI 200, the user can select a process that they would like to use to generate the model for the project. A model process generation list 1440 includes model generation software that can be used to generate the model. The stepper 444 is now in a model settings state to indicate to the user that the user is now generating the model. The stepper 444 further indicates that the set up and import have been completed.

Performance metrics will vary by model types. For example a data analytics model has different performance metrics than M. Also, performance metrics for the sub type of the model can indicate different performance metrics. For example, performance metrics are different for regression and classification models. The GUI 200 accounts for these nuances.

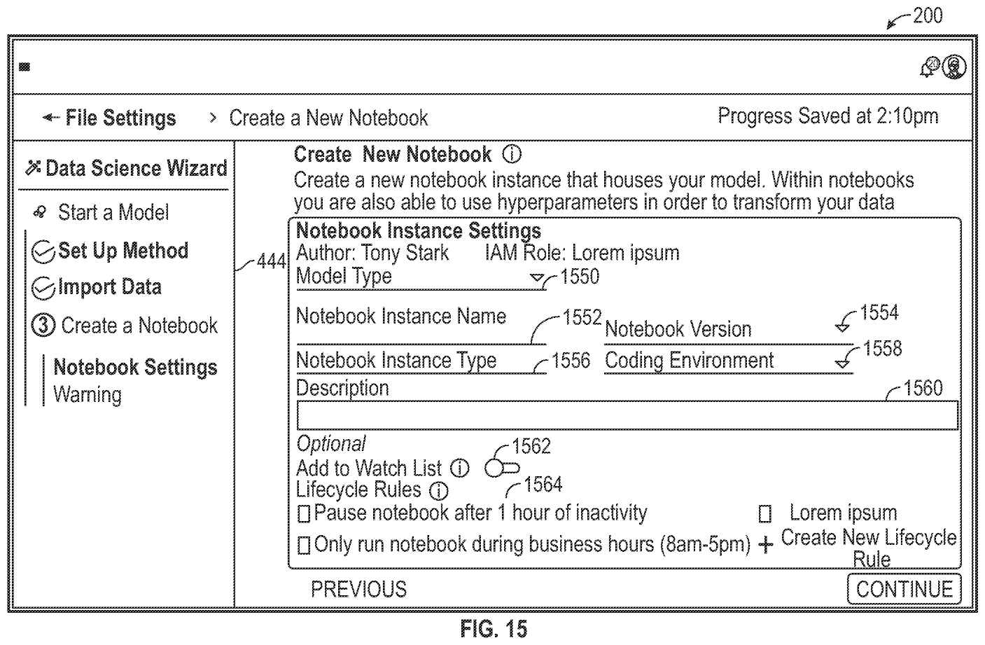

FIG. 15 illustrates, by way of example, a diagram of the GUI 200 provided responsive to the user selecting a model generation process in the GUI 200 of FIG. 14. The GUI 200 of FIG. 15 allows the user to define metadata and of the model. The metadata defined can be used with other description or objective text, or tags to help the user through the data science project generation process. The GUI 200 of FIG. 15 includes dropdown menus 1550, 1554, 1556, 1558, input boxes 1552, 1560, a binary control 1562, and a radio button list 1564. The model type drop down menu 1550 provides the user with a delineated list of model types, such as a regression, NN, or the like. The model instance name input box allows the user to define a name for the model. The model version dropdown menu 1554 provides the user with a delineated list of version numbers. The model instance type dropdown menu 1556 provides the user with more granular list of model types than the model type dropdown menu 1550. The coding environment dropdown menu 1558 provides the user with a delineated list of coding environments that can be used to generate the model. The description input box 1560 allows the user to describe the model using text. The add to watch list control 1562 allows the user to indicate whether they want to receive an alert when the model is updated. The lifecycle rules radio button list 1564 allows the user to set rules associated with the model. The rules provided in FIG. 15 are pausing the model after a specified period of time, only running the model in a specified time frame, lorem ipsum (filler), or a custom rule. The stepper 444 has not changed state from that shown in FIG. 14. The list 1564 saves user and resource time and money.

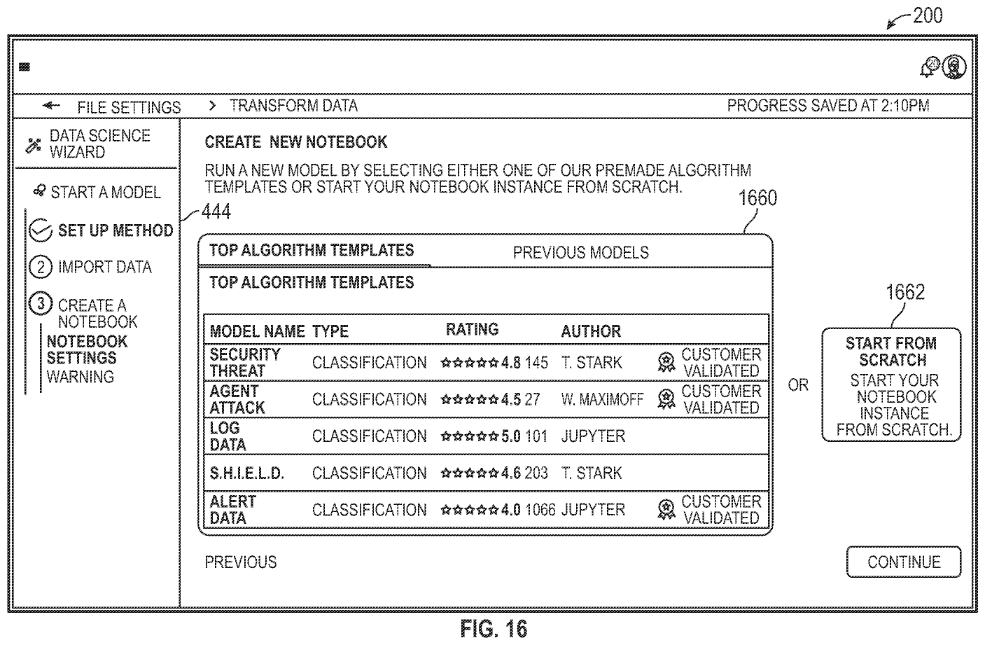

FIG. 16 illustrates, by way of example, a diagram of the GUI 200 provided responsive to the user selecting a continue control on the GUI 200 in the state illustrated in FIG. 15. The GUI 200 of FIG. 16 is presented as part of the operation 110 of FIG. 1. The GUI 200 of FIG. 16 includes a recommended model templates list 1660, and a start from scratch control 1662. The list 1660 can be generated by the model recommender operator 118. The list 1660 includes models that have been used on a prior data science project or were pre-loaded into the data science environment. Responsive to selecting the control 1662, a user can define a model that is not on the list 1660. The newly defined model can then be added to the list 1660. The stepper 444 in the GUI 200 of FIG. 16 is in the same state as illustrated in FIG. 15. Responsive to selecting a continue control in the GUI 200 of FIG. 16, the user can be presented with the model generation process associated with a selected model. Responsive to selecting the start from scratch control 1662, the user can be presented with the GUI 200 of FIG. 14.

Responsive to selecting the continue control on the GUI 200 in the state illustrated in FIG. 16, the user can be presented with a warning. The warning essentially tells the user that they are about to exit the wizard and go to a model database. The model generated by the user will be at the top and may be in a thinking status as it is being prepared. Once it has changed to the ready status the user can receive a notification and be able to edit the model. The notification can link to the new notebook and contain next steps on how to continue the data science project lifecycle. The notification can be given in case the user wants to leave the page and work on something else while it is being created. This is a helpful feature as models can take a good amount of time to create and load. After creating the model instance, the user can be directed to a model database list.

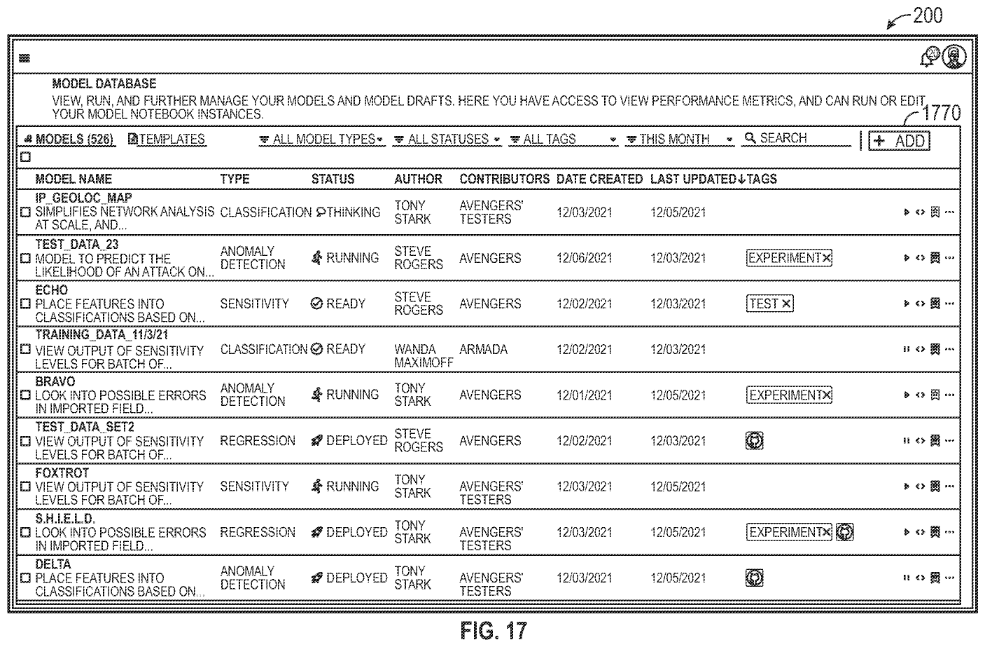

FIG. 17 illustrates, by way of example, a diagram of the GUI 200 in a state that provides a view of a model database list 1770. The list 1770 delineates models that have been generated using the data science environment or have been uploaded to a model database. Details included in the list 1770 include model name, model type (e.g., regression, anomaly detection, sensitivity, classification, or the like), status, (e.g., running, ready, or deployed), author, contributors, date created, date last updated, tags, among others. The model database can be local or remote, hosted by a cloud provider or other entity, or the like.

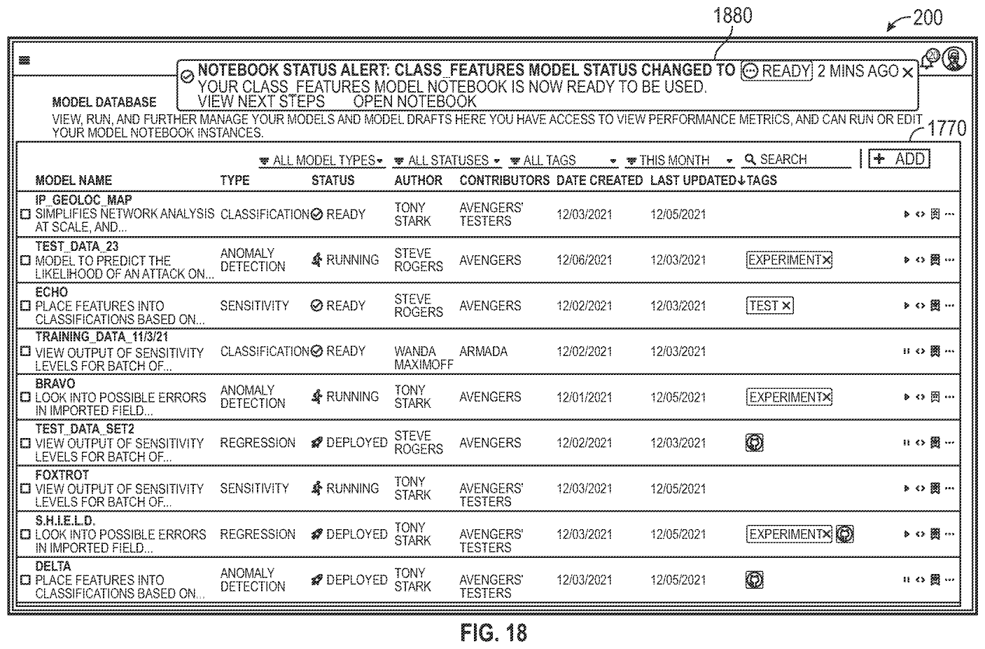

FIG. 18 illustrates, by way of example, a diagram of the GUI 200 of FIG. 17 after a model is ready to be edited, run, or deployed. A notification 1880 can appear in the GUI 200 indicating to the user that the model is ready to be run, edited, or deployed.

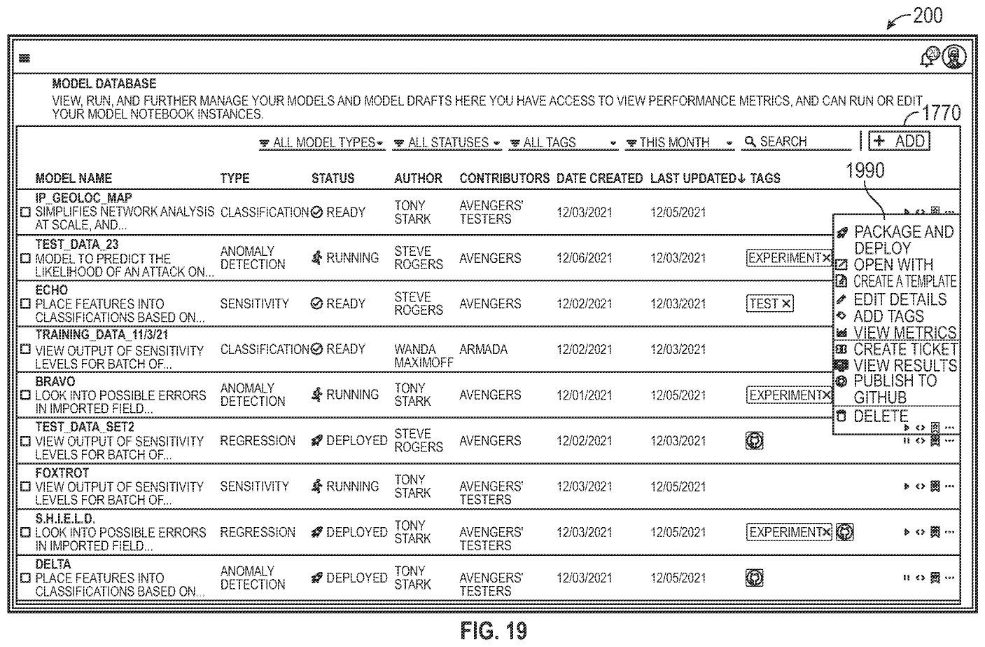

FIG. 19 illustrates, by way of example a diagram of the GUI 200 in a state after the user has selected an ellipse control on the list 1770. The ellipse control, when selected can provide a popup control 1990 that allows a user to select from further options that are not delineated on the list 1770. The control 1990 allows the user to edit details of the model, add tags to the model, view performance metrics of the model, create a new work ticket, package and deploy the model, publish the model, or delete the model.

FIG. 20 illustrates, by way of example, a diagram of the GUI 200 in a state after the user has selected the view metrics control from FIG. 19. After running the model, the user can analyze its performance metrics using the GUI 200 of FIG. 20.

A name of the model appears on the GUI 200 of FIG. 20, along with the author, and a description of the model. More details are presented as a popup on the GUI 200 responsive to the user selecting a control 2034. Model controls 2034 allow the user to further tune the model, package and deploy the model, pause the model, among others.

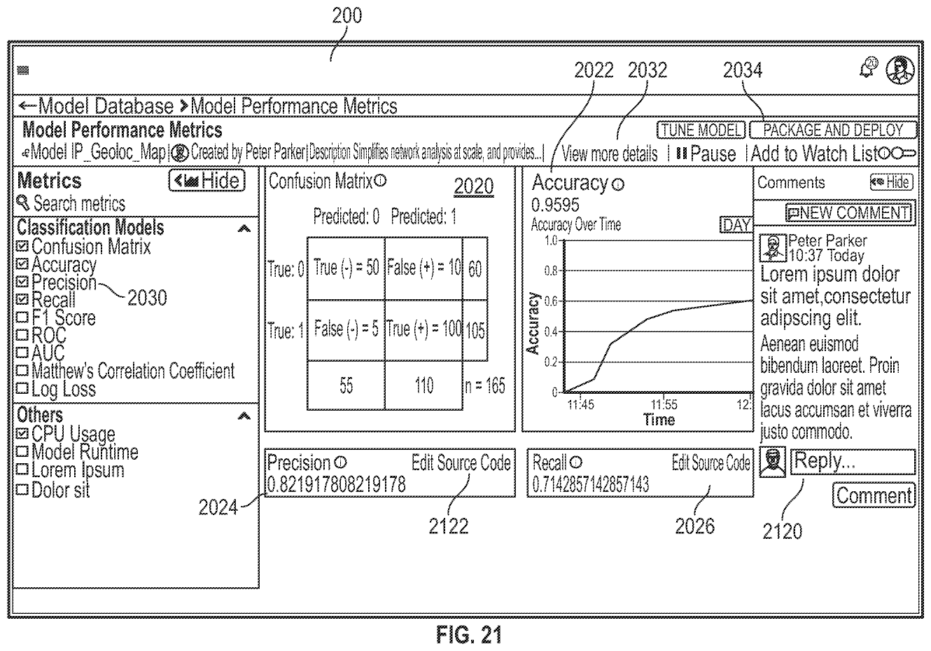

A model performance dashboard provides visual depictions of the model performance. Graphs 2020, 2022, 2028, of confusion, accuracy and processor usage are illustrated in the dashboard of FIG. 20 along with textual values 2024, 2026 of precision and recall of the model. The dashboard can automatically load the most common metrics for the specific model type, but the user is able to select what they would like to see in a radio button list 2030. Responsive to selecting a show control 2036 the comments in the GUI 200 of FIG. 21 are presented.

Performance metrics will vary by model types. For example a data analytics model has different performance metrics than M. Also, performance metrics for the sub type of the model can indicate different performance metrics. For example, performance metrics are different for regression and classification models. The GUI 200 accounts for these nuances.

Another performance metric that can be visualized is model drift. Model drift adds the attribute of confidence to existing metrics. Drift exists where an ML model is confidently incorrect. The confidence metric can be tracked for model degradation based on the published baseline.

FIG. 21 illustrates, by way of example, a diagram of an embodiment of a state of the GUI 200 after the user selects the show control 2035 on the GUI 200 of FIG. 20. The GUI 200 includes a view of the comments 2120 made on the model in the model metrics dashboard. The comments 2120 made on this specific model or tuning job are provided. These comments can be made by the user or others on the project team, such as to provide feedback, encouragement, expertise, or the like. There is an edit source code link 2122 that, when selected, provides a user with a popup view of the source code used to generate a corresponding result.

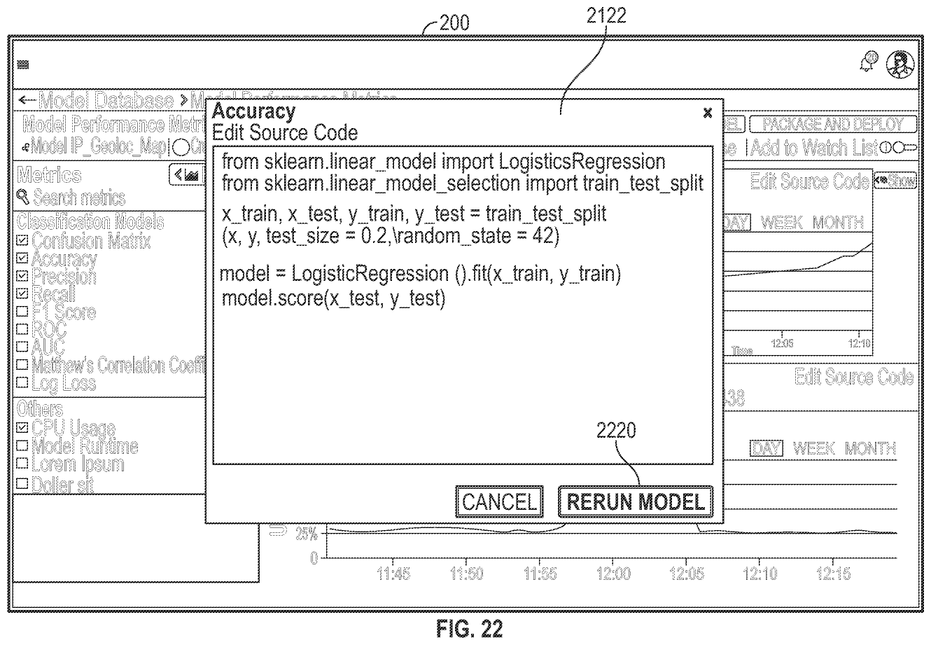

FIG. 22 illustrates, by way of example, a diagram of an embodiment of a state of the GUI 200 after the user selects the edit source code control 2122. The source code is displayed in a popup window 2122 in such a manner that allows the user to edit the code directly from the popup window 2122. The user can select a control 2220 that causes the code to be compiled and executed the on prior results of the model or reruns the model and executes the new code on new results.

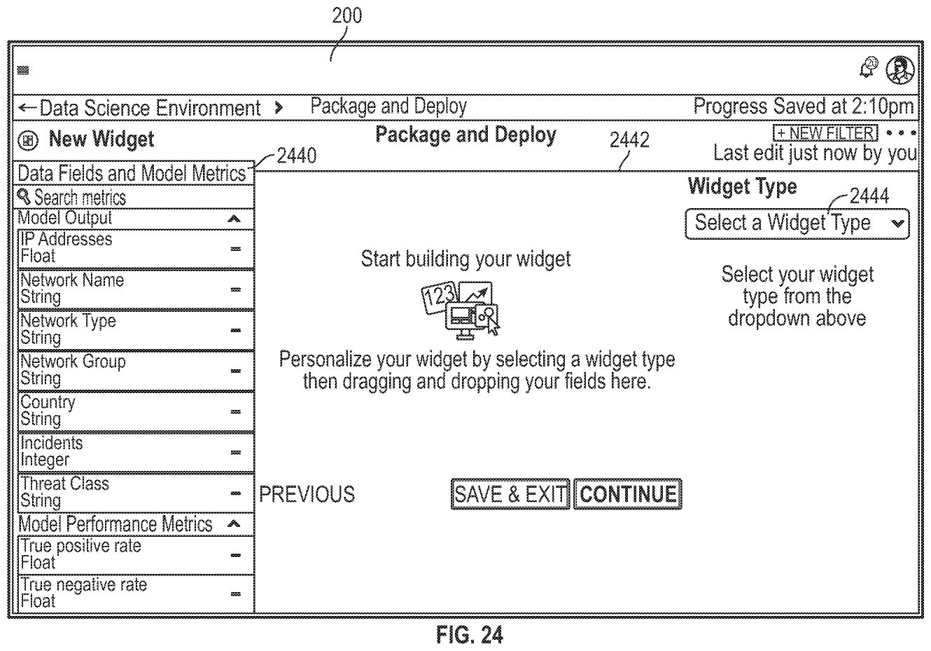

FIG. 23 illustrates, by way of example, a diagram of the GUI 200 in a state that supports packaging and deploying a widget. The GUI 200 can be provided by selecting the package deploy control of the controls 2034 or selecting package and deploy in the list 1990, among other ways. The GUI 200 in the state illustrated in FIG. 23 includes a model type button 2330, a project type button 2331, and a widget type button 2332. The model type button 2330, when selected, starts a process of walking the data scientist through a model deployment process. The project type button 2331, when selected, starts a process of walking the data scientist through a project deployment process. The widget type button 2332, when selected, starts a process of walking the data scientist through a widget deployment process. The model deployment deploys the model for others to use. The project deployment process is a combination of deploying the model and the widget. The widget deployment deploys results of the model along with a visualization for others to use. Other deployments are possible and within the scope of embodiments. Responsive to selecting the widget type control 1332, the user is presented with a visualization creation step as in FIG. 24. Responsive to selecting the model deployment control 2330, the user is presented with a copy of the model project to edit for others to use.

FIG. 24 illustrates, by way of example, a diagram of an embodiment of the GUI 200 in a state for generating a widget. The GUI 200 of FIG. 24 includes a widget dashboard 2442. The user can select data fields, model metrics, or the like, to be displayed on the widget using the list 2440. The user can select the widget type using a dropdown menu 2444 or widget types. Widget types include graphs, maps, images, files, or the like. The widget types can include subtypes and options, such as color, shape, size, or other format of points that represent the data or metric.

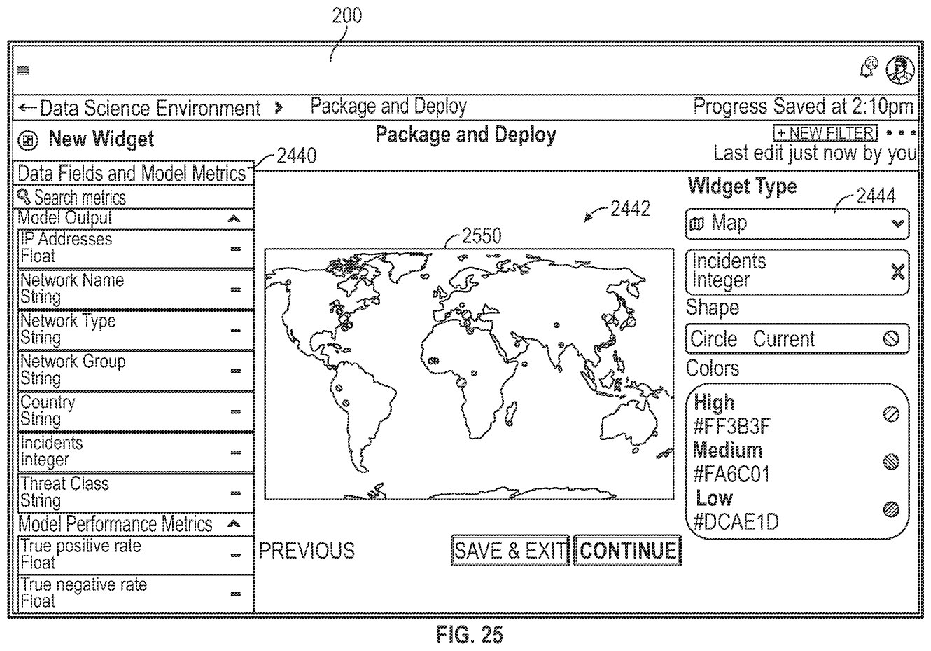

FIG. 25 illustrates, by way of example, a diagram of an embodiment of the state of the GUI 200 of FIG. 24 after the widget type selected using the control 2444 and a model output has been selected using the control 2440. The GUI 200 of FIG. 25 includes a map graphic 2550 with data points of the selected type and selected configuration.

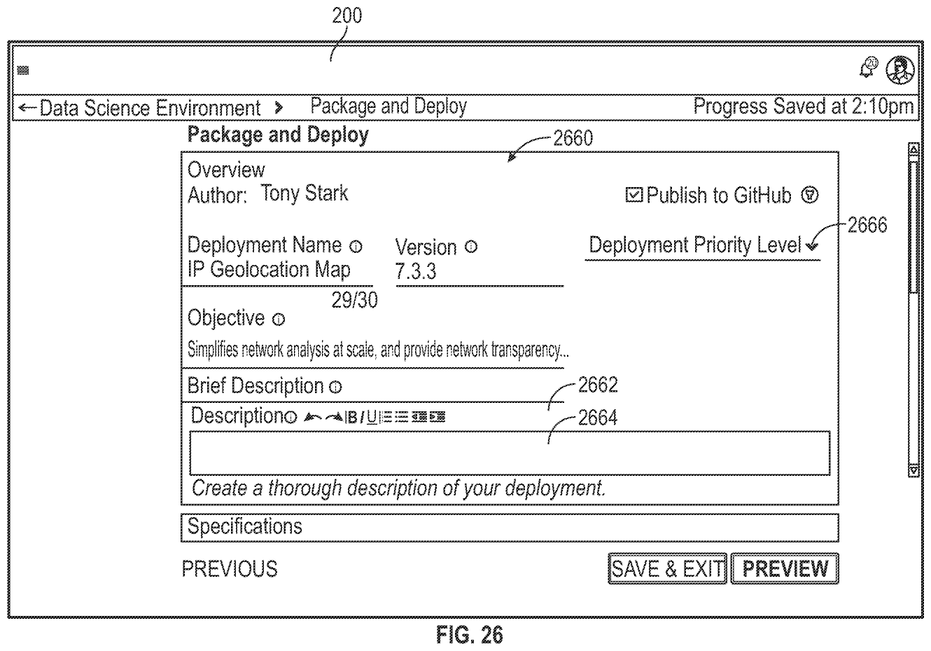

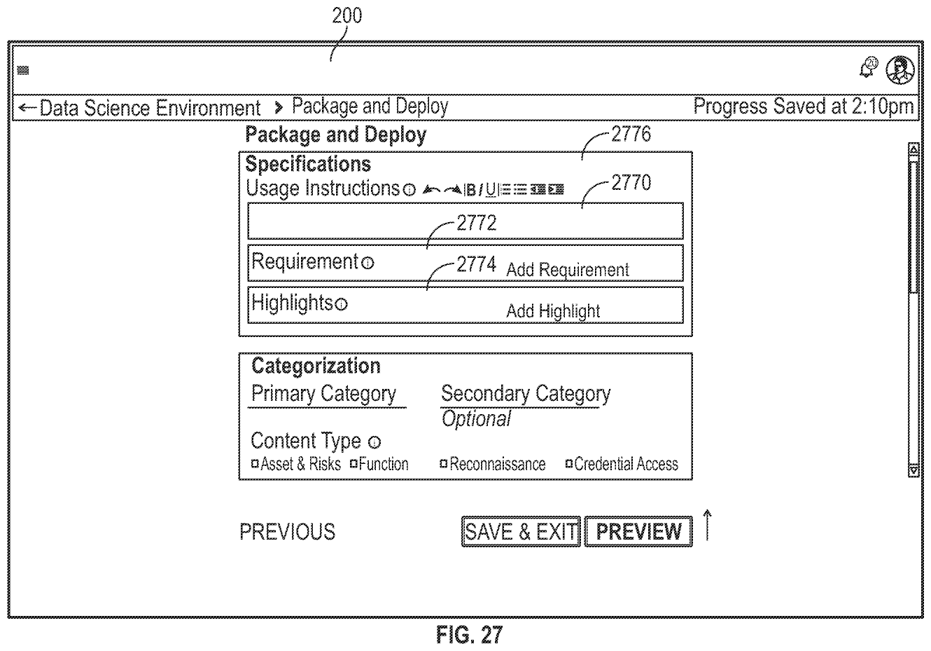

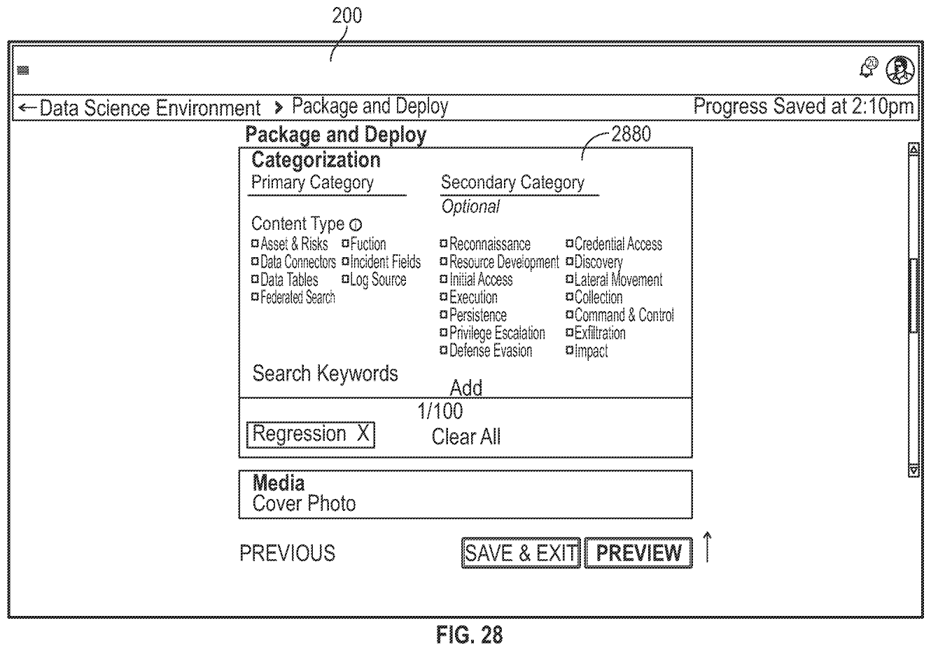

FIG. 26 illustrates, by way of example, a diagram of an embodiment of the state of the GUI 200 after the continue control of FIG. 25 is selected. The GUI 200 of FIG. 26 is a configuration page for the operation 112. Using the GUI 200 of FIG. 26, the user configures and ultimately finds out what the deployment will look like when it is in the marketplace and what others will see when looking at the deployment. The GUI 200 of FIG. 26 includes some high level data 2660 regarding the deployment (e.g., deployment name, version, objective, or the like). The GUI 200 of FIG. 26 further includes an input box 2662 in which the user can enter text for a brief description of the goal or functionality of the deployment. A more detailed description can be provided in a description input box 2664. A priority control 2666 allows the user to influence how fast the deployment is processed. Some fields of the GUI 200 of FIG. 26 can be auto-populated like author, deployment name, version, and objective. All other fields and controls are configurable. If the user scrolls down in the form they are able to see the other fields, which are presented on FIGS. 27 and 28.

FIG. 27 illustrates, by way of example, a diagram of the state of the GUI 200 after the user scrolls down on the GUI 200 of FIG. 26. The user can fill out a specifications input box 2776 in which the user provides deployment usage instructions (e.g., how to operate the deployment, or the like) in input box 2770, requirements (e.g., computer and time requirements for executing the deployment) in input box 2772, and highlights (any main selling points of the deployment) in input box 2774.

FIG. 28 illustrates, by way of example, a diagram of the state of the GUI 200 after the user scrolls down on the GUI 200 of FIG. 27. The GUI 200 of FIG. 28 include a radio button list 2880 of categorization fields. The radio button list 2880 includes a primary category (how the deployment will be sorted in the marketplace), an optional secondary category such as content type, search keywords (keywords that would be associated with the deployment if someone searched the marketplace).

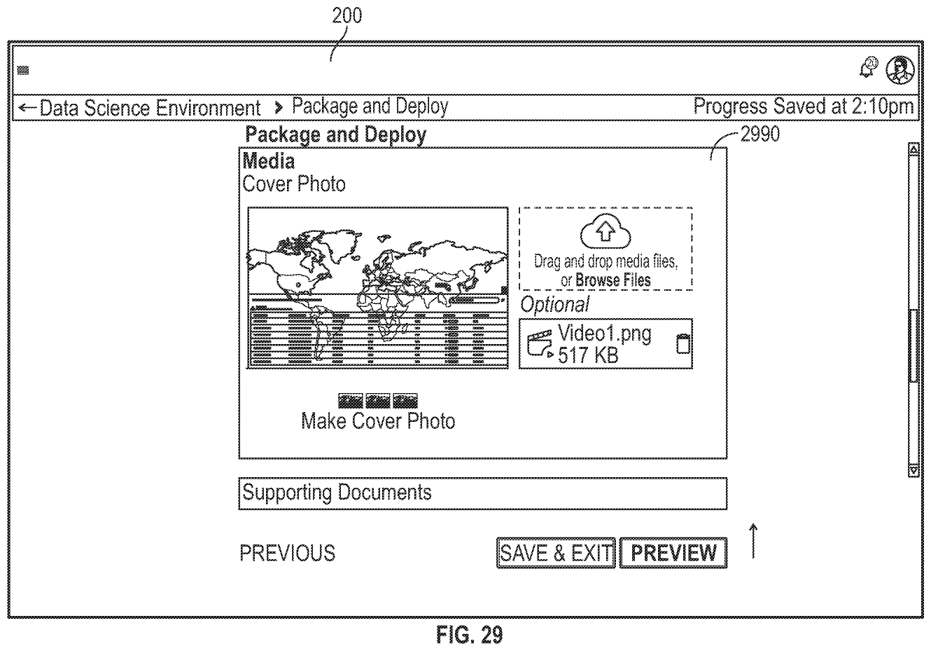

FIG. 29 illustrates, by way of example, a diagram of the state of the GUI 200 after the user scrolls down on the GUI 200 of FIG. 28. The GUI 200 of FIG. 28 includes a media dashboard 2990. The media dashboard 2990 includes a drag and drop control to which the user can drag and drop any media files that they want to be part of the deployment listing on the marketplace, such as videos of the deployment in action or a cover photo for the listing. The GUI includes automatically generated images of the deployment to choose from.

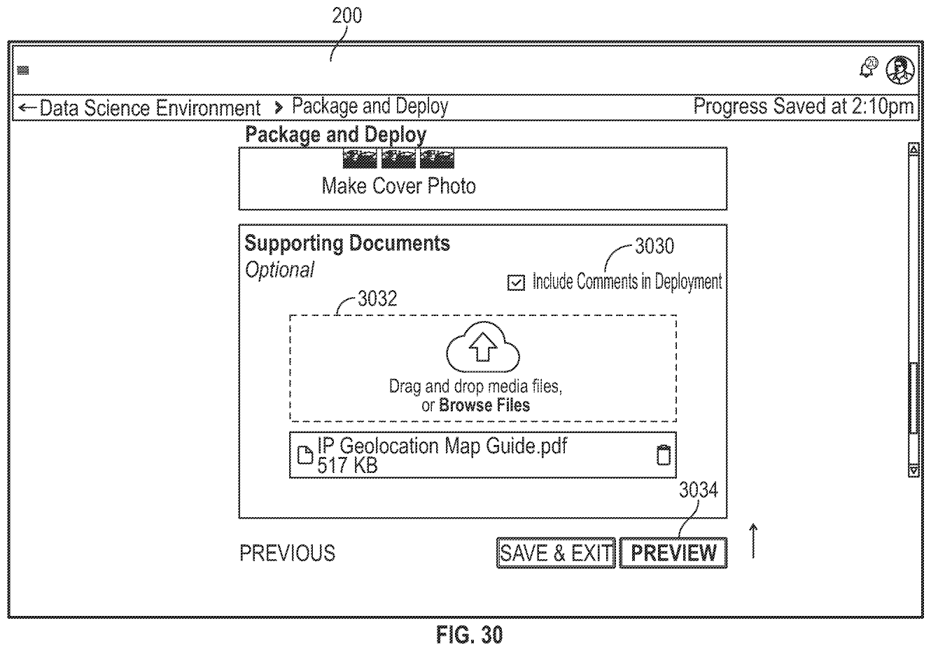

FIG. 30 illustrates, by way of example, a diagram of the state of the GUI 200 after the user scrolls down on the GUI 200 of FIG. 29. There is a checkbox 3030 that, if selected, deploys the model with all of the collaborator comments with it. The GUI 200 of FIG. 29 includes a drag and drop control 3032, similar to the control of the dashboard 2990, through which the user can add documentation on how to use the deployment or other information they would like to provide to support use of the deployment.

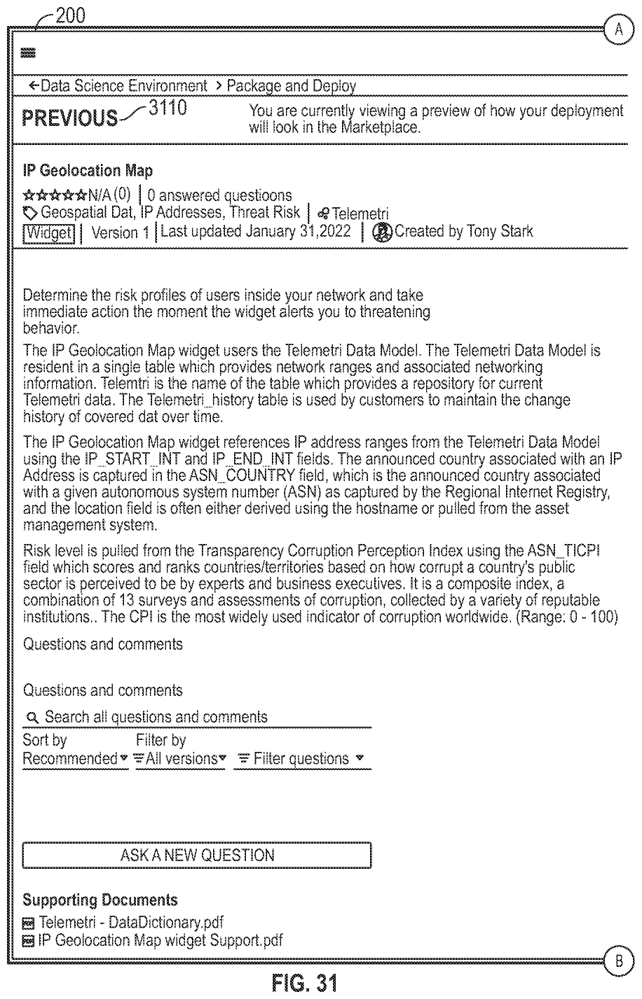

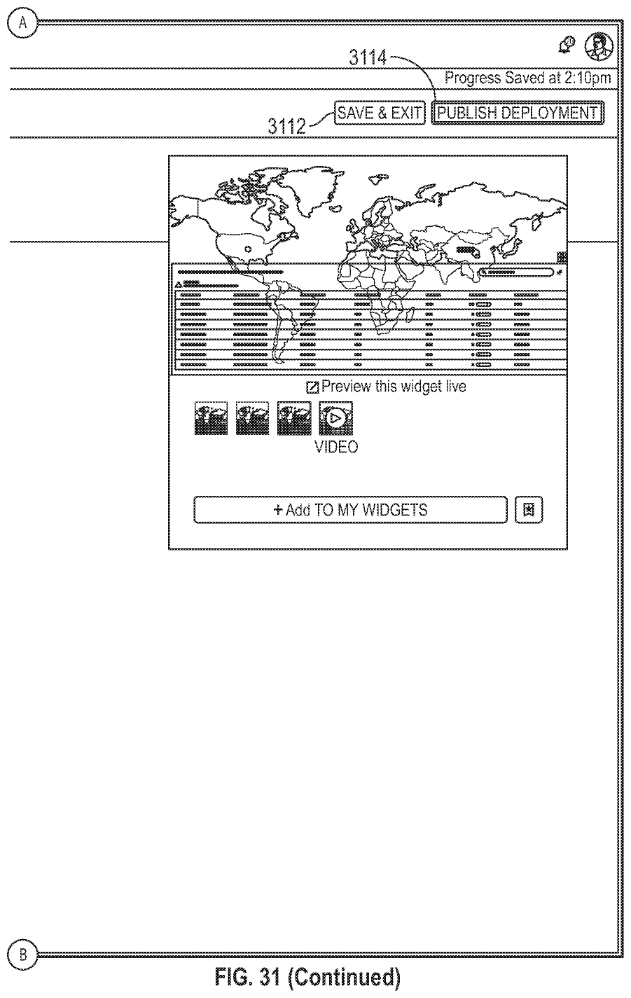

FIG. 31 illustrates, by way of example, a diagram of a state of the GUI 200 presented responsive to the user selecting a preview button 3034 on the GUI 200 of FIG. 30. At the top there is a disclaimer bar informing the user that they are looking at a preview. The GUI 200 of FIG. 31 also has the options to go back to the previous page, save and exit, or publish your deployment to the marketplace using controls 3110, 3112, and 3114, respectively.

The project database and the GUI 200 presentation of the project database to the user was visited in FIGS. 2 and 3. The project database is accessible through its card 228 on the homepage (the GUI 200 of FIG. 2) or through a navigation bar 3240.

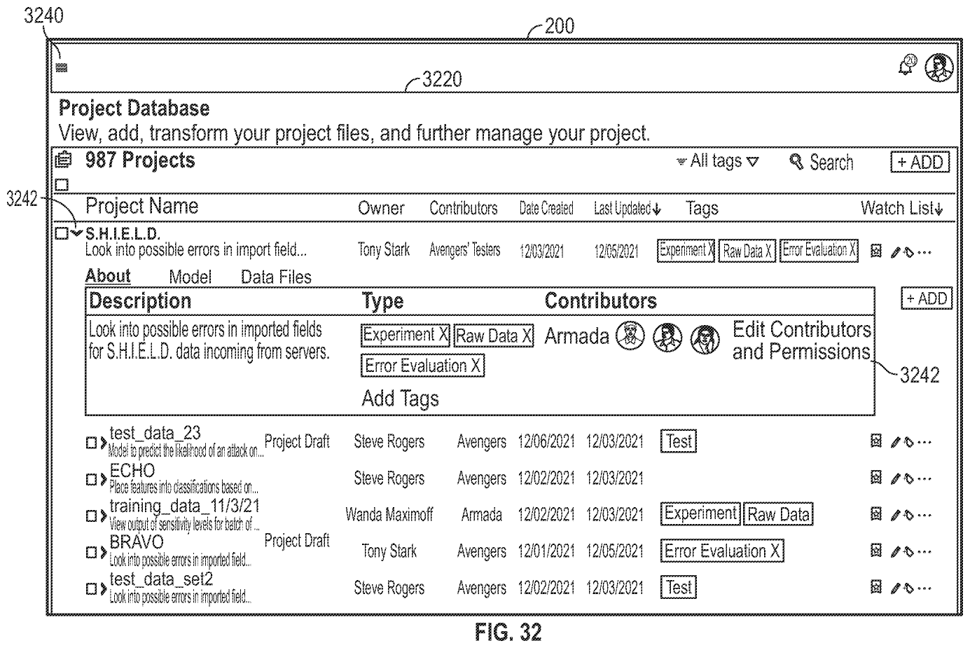

FIG. 32 illustrates, by way of example, a diagram of a state of the GUI 200 responsive to a user selecting a caret control 3242 proximate a project name. The presentation of the project database is similar to the presentation of the model database. This project database houses all of the projects that house the models. The GUI 200 of FIG. 32 provides pertinent project details on the table such as project name, description, author, team, date created, last updated, and any tags the project may have. The interface to the project database provides some actions, such as editing the line item details (pencil icon), adding a new tag to the project (add tag icon), deleting the project (trash can icon), and adding the project to the watch list (bookmark icon). If a project is selected using the checkboxes at the left, then the user is able to delete what is selected at the top right using the delete button, allowing the user to delete multiple projects at once. The user is also able to create a new project using the add button at the top right.

The project details pop-up page (FIG. 3) shows all details for that specific project including the author, team, date created, description, objective, any tags that were given to the project, when it was last updated and status. Then underneath there is a table that contains the models, data files, and activity log (log of any edits/changes made to the project details, its models, or data files) for the project. There are also links on the right for actions you can take on the project. At the top right there are other actions like adding/removing this project from your watch list (bookmark icon), the ability to edit these project details (pencil icon), and a close window button (X icon).

The GUI 200 of FIG. 32 includes a drilldown details drawer 3242. The first tab of the drawer is the about tab. The about tab provide shows the full project description, full tags list with the option to add more, team name with member images, and the option to edit the team members and their permissions. The drawer 3242 is part of the projects dashboard 3220 that delineates projects for which the user has access.

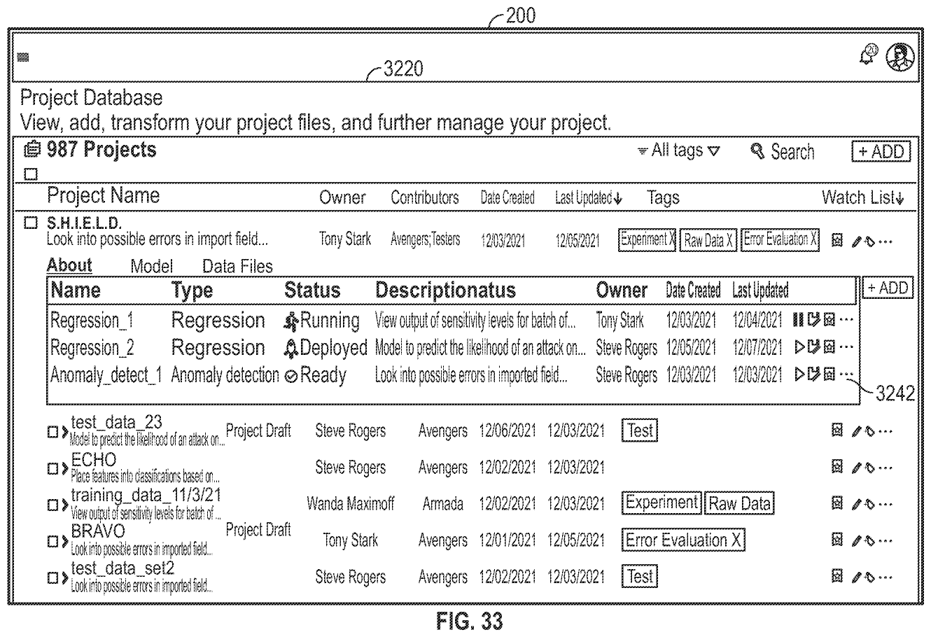

FIG. 33 illustrates, by way of example, a diagram of a state of the GUI 200 responsive to the user selecting the models tab of the drawer 3242. The models tab presents a table of all models created within the project and pertinent details such as model name, type, status, description, author, date created, last updated, as well as the other options available in the model database (edit details, delete, add to watch list, view model performance metrics, edit notebook).

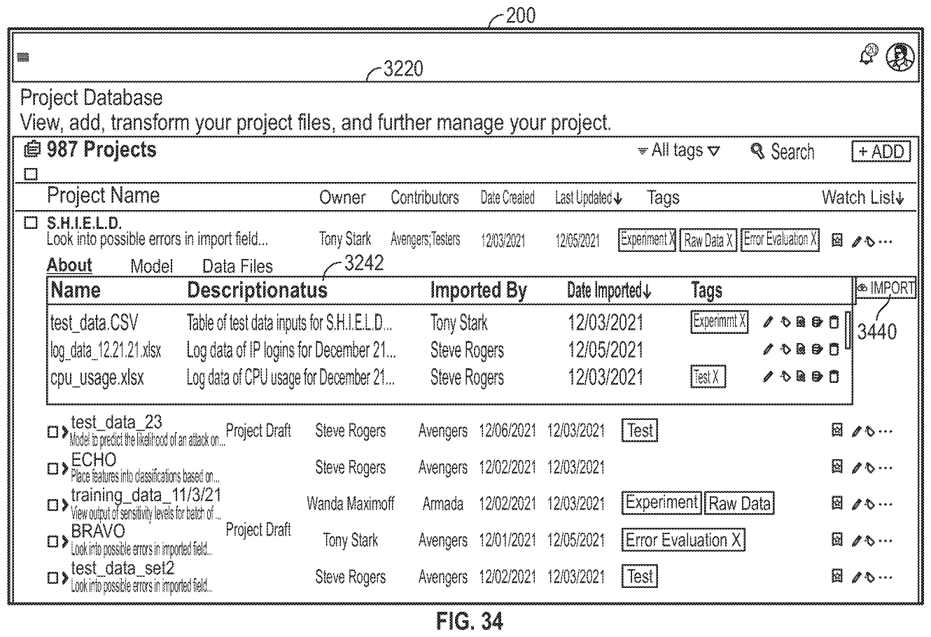

FIG. 34 illustrates, by way of example, a diagram of a state of the GUI 200 responsive to the user selecting the data files tab of the drawer 3242. The data files tab presents a table of all data files imported to the project and pertinent details such as file name, description, user that imported it, date imported, and any tags it may have. There are also additional actions such as adding a tag (add tag icon), editing the file settings (pencil icon), deleting the file (trash can icon), view file (file magnifying icon), and transform data (sheet icon). The user can also import new files to the project using the import new file button 3440.

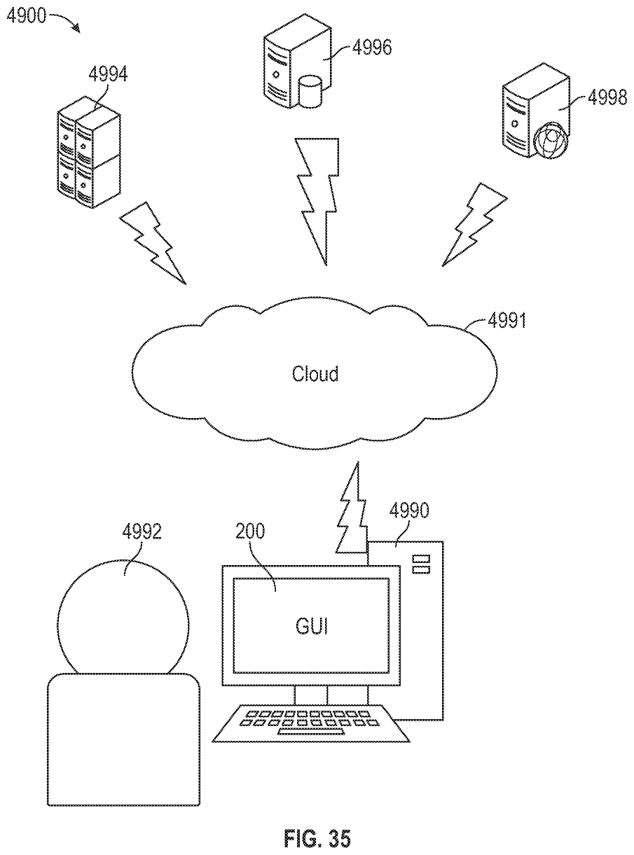

FIG. 35 illustrates, by way of example, a diagram of an embodiment of a system 4900 in which the GUI 200 improves data science project interaction. The system 4900 includes a user device 4990, an application server 4994, a database server 4996, and a content management server 4998. The user device 4990 can access the servers 4994, 4996, 4998 through a cloud network 4991 or other type of network. The application server 4994 provides functionality of code editors, project, model, or dashboard generators, data transformation and cleansing, statistics packages (e.g., R), notebook configuration tools, or other applications of consequence to a data scientist or data engineer. The database 4996 stores the model, project, dashboard, or widget data, results of model operation, metadata for the model, project, dashboard, or widget (e.g., author, tags, objective, description, brief description, tags, date created, data last updated, object location, whether the model was flagged for inclusion in a list (e.g., my dashboards, projects, etc.) etc.), model hyperparameters, training data, testing data, model metrics, among other data of relevance to the data scientist. The content management server 4998 provides for collaboration in the applications. The content management server 4998 hosts an application that is used to manage content, allowing multiple contributors to create, edit and publish. Content in the content management server 4998 is stored in the database server 4996 and displayed in a presentation layer based on a set of templates populated and provided to the GUI 200.

The GUI 200 conceals all of the expertise required to connect to, interact with, and otherwise access the functionality of the servers 4994, 4996 4998. The GUI 200 further conceals the knowledge of what server is to be connected to at a given point in a data science project deployment process and the actions that are to be performed. By providing a presentation of the series of GUI states based on the user interaction with the GUI, the data scientist, data engineer, or other user does not need to know what application to connect to, how to connect to the application, where data resides, how the data accessed, where the data is accessed from, or other knowledge typically needed to complete a data science project.

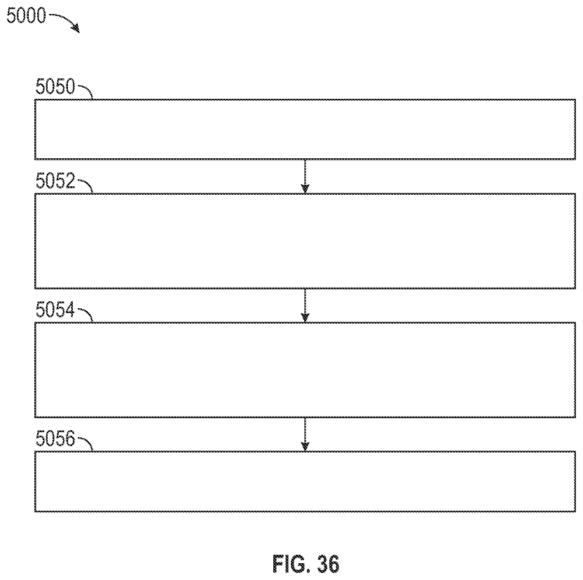

FIG. 36 illustrates, by way of example, a diagram of an embodiment of a method 5000 for improved data science project deployment and management. The method 5000 as illustrated includes providing, on the GUI, a first graphical software control that causes a project creation wizard to be presented on the GUI, at operation 5050; providing, on the GUI, a second graphical software control that causes previously generated projects to be presented on the GUI, at operation 5052; providing, on the GUI, a third graphical software control that causes previously generated models to be presented on the GUI, at operation 5054; and providing, on the GUI, a fourth graphical software control that causes a marketplace of data science projects to be presented on the GUI, at operation 5056.

The method 5000 can further include providing, on the GUI and concurrently with the first, second, third, and fourth graphical software controls, a selectable list of the previously generated projects. The method 5000 can further include providing, on the GUI and concurrently with the first, second, third, and fourth graphical software controls, a selectable list of the previously generated models. The method 5000 can further include providing, on the GUI and concurrently with the first, second, third, and fourth graphical software controls, a watchlist of models, projects, and deployments that a user has previously indicated is to be included on the watchlist.

The method 5000 can further include, wherein the wizard configures the GUI in a series of consecutive states that guides a user through data acquisition, model generation, and deployment of the model or a widget to the marketplace. The method 5000 can further include, wherein the series of consecutive states further guides the user through data cleansing. The method 5000 can further include, wherein the series of consecutive states further guides the user through data transformation.

The method 5000 can further include receiving, by a model recommender that compares a representation of a project objective, project description, and tags of a model being generated to corresponding descriptions of previously generated models, a list of recommended models. The method 5000 can further include providing, by the GUI, the list of recommended models in guiding the user through model generation. The method 5000 can further include receiving, by a visual analytics recommender that compares a representation of a project objective, project description, and tags of a deployment being generated to corresponding descriptions of previously generated deployments, a list of recommended deployments. The method 5000 can further include providing, by the GUI, the list of recommended deployments in guiding the user through the deployment of the model.

The method 5000 can further include receiving, by a data quality score operator, a data quality score. The method 5000 can further include providing, by the GUI, the data quality score in guiding the user through the data acquisition.

Existing solutions for data science project help scored a 46 of 100 for usability. The GUI 200 of embodiments that provides the functionality of a complete analytics platform received a notional usability score of 96 of 100, thus increasing usability by 111%. The GUI 200 of embodiments further increases learnability by 80% according to a survey. Further, the survey indicated, that, when asked

“on a scale of 1-5, with 1 meaning very difficult and 5 meaning very easy: how difficult would you say it is to create a model using the tools you are familiar with?” (4 participants) average of 1.83;

“how difficult would you say it is to deploy a model using the tools you are familiar with?” (4 participants) average of 2.25;

“ how difficult would you say it is to create a model in the Data Science Environment?” (4 participants) average of 3.7; and

“how difficult would you say it is to deploy a model in the Data Science Environment?” (4 participants) average of 4.3.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as object recognition, device behavior modeling (as in the present application) or the like. The model recommender 118, data quality score 116, visual analytics recommender 120, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph-if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached-and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

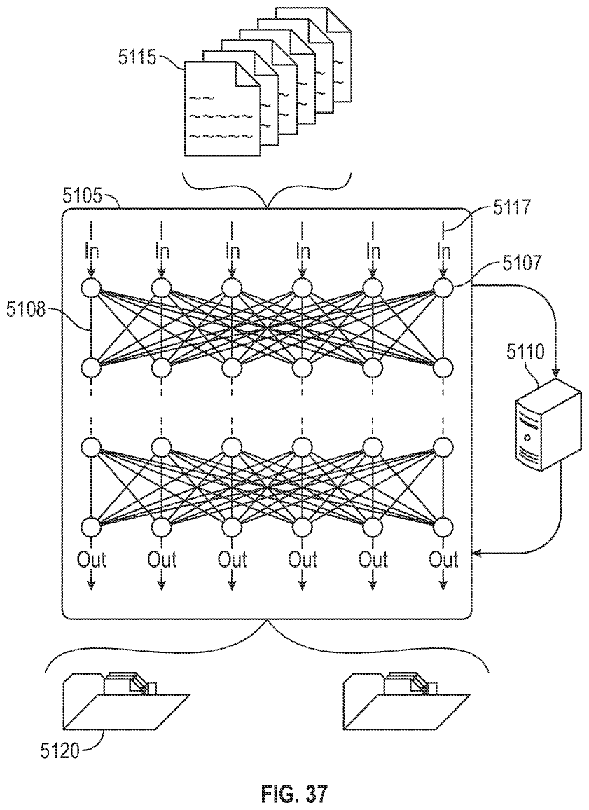

FIG. 37 is a block diagram of an example of an environment including a system for neural network training. The system includes an artificial NN (ANN) 5105 that is trained using a processing node 5110. The processing node 5110 may be a central processing unit (CPU), graphics processing unit (GPU), field programmable gate array (FPGA), digital signal processor (DSP), application specific integrated circuit (ASIC), or other processing circuitry In an example, multiple processing nodes may be employed to train different layers of the ANN 5105, or even different nodes 5107 within layers. Thus, a set of processing nodes 5110 is arranged to perform the training of the ANN 905.

The set of processing nodes 5110 is arranged to receive a training set 5115 for the ANN 5105. The ANN 5105 comprises a set of nodes 5107 arranged in layers (illustrated as rows of nodes 5107) and a set of inter-node weights 5108 (e.g., parameters) between nodes in the set of nodes. In an example, the training set 5115 is a subset of a complete training set. Here, the subset may enable processing nodes with limited storage resources to participate in training the ANN 5105.

The training data may include multiple numerical values representative of a domain, such as an image feature, or the like. Each value of the training or input 5117 to be classified after ANN 5105 is trained, is provided to a corresponding node 5107 in the first layer or input layer of ANN 5105. The values propagate through the layers and are changed by the objective function.

As noted, the set of processing nodes is arranged to train the neural network to create a trained neural network. After the ANN is trained, data input into the ANN will produce valid classifications 5120 (e.g., the input data 5117 will be assigned into categories), for example. The training performed by the set of processing nodes 5107 is iterative. In an example, each iteration of the training the ANN 5105 is performed independently between layers of the ANN 5105. Thus, two distinct layers may be processed in parallel by different members of the set of processing nodes. In an example, different layers of the ANN 5105 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 5107 (e.g., neurons) are trained independently. In an example, the nodes are trained on different hardware.

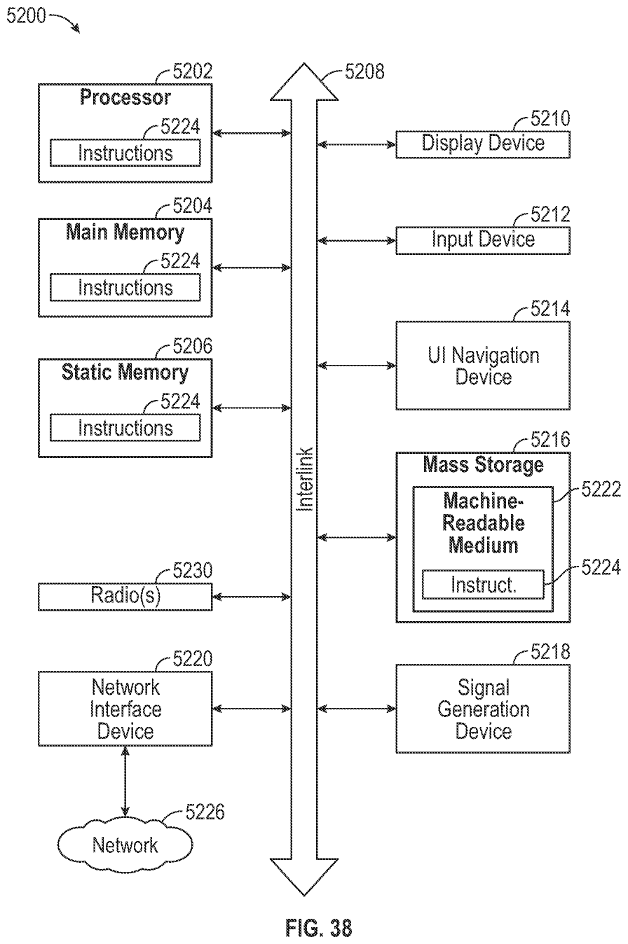

FIG. 38 illustrates, by way of example, a block diagram of an embodiment of a machine in the example form of a computer system 5200 within which instructions, for causing the machine to perform any one or more of the methods discussed herein, may be executed. One or more of the operations 102, 104, 106, 108, 110, 112, 114, GUI 200, method 5000, controls, dashboard, or other device, component, operation, or method discussed can include, or be implemented or performed by one or more of the components of the computer system 5200. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 5200 includes a processor 5202 (e.g., a central processing unit (CPU), a graphics processing unit (GPU) or both), a main memory 5204 and a static memory 5206, which communicate with each other via a bus 5208. The computer system 5200 may further include a video display unit 5210 (e.g., a liquid crystal display (LCD) or a cathode ray tube (CRT)). The computer system 5200 also includes an alphanumeric input device 5212 (e.g., a keyboard), a user interface (UI) navigation device 5214 (e.g., a mouse), a mass storage unit 5216, a signal generation device 5218 (e.g., a speaker), a network interface device 5220, and a radio 5230 such as Bluetooth, WWAN, WLAN, and NFC, permitting the application of security controls on such protocols.

The mass storage unit 5216 includes a machine-readable medium 5222 on which is stored one or more sets of instructions and data structures (e.g., software) 5224 embodying or utilized by any one or more of the methodologies or functions described herein. The instructions 5224 may also reside, completely or at least partially, within the main memory 5204 and/or within the processor 5202 during execution thereof by the computer system 5200, the main memory 5204 and the processor 5202 also constituting machine-readable media.

While the machine-readable medium 5222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 5224 may further be transmitted or received over a communications network 5226 using a transmission medium. The instructions 5224 may be transmitted using the network interface device 5220 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### ADDITIONAL NOTES AND EXAMPLES

Example 1 includes a method for, by a graphical user interface (GUI), for data analytics and machine learning (ML) model project deployment, the method comprising providing, on the GUI, a first graphical software control that causes a project creation wizard to be presented on the GUI, providing, on the GUI, a second graphical software control that causes previously generated projects to be presented on the GUI, providing, on the GUI, a third graphical software control that causes previously generated models to be presented on the GUI, and providing, on the GUI, a fourth graphical software control that causes a marketplace of data science projects to be presented on the GUI.

In Example 2, Example 1 further includes providing, on the GUI and concurrently with the first, second, third, and fourth graphical software controls, a selectable list of the previously generated projects.

In Example 3, at least one of Examples 1-2 further includes providing, on the GUI and concurrently with the first, second, third, and fourth graphical software controls, a selectable list of the previously generated models.

In Example 4, at least one of Examples 1-3 further includes providing, on the GUI and concurrently with the first, second, third, and fourth graphical software controls, a watchlist of models, projects, and deployments that a user has previously indicated is to be included on the watchlist.

In Example 5, at least one of Examples 1-4 further includes, wherein the wizard configures the GUI in a series of consecutive states that guides a user through data acquisition, model generation, and deployment of the model or a widget to the marketplace.

In Example 6, Example 5 further includes, wherein the series of consecutive states further guides the user through data cleansing.

In Example 7, at least one of Examples 1-6 further includes, wherein the series of consecutive states further guides the user through data transformation.

In Example 8, at least one of Examples 5-7 further includes receiving, by a model recommender that compares a representation of a project objective, project description, and tags of a model being generated to corresponding descriptions of previously generated models, a list of recommended models, and providing, by the GUI, the list of recommended models in guiding the user through model generation.

In Example 9, at least one of Examples 5-8 further includes receiving, by a visual analytics recommender that compares a representation of a project objective, project description, and tags of a deployment being generated to corresponding descriptions of previously generated deployments, a list of recommended deployments, and providing, by the GUI, the list of recommended deployments in guiding the user through the deployment of the model.

In Example 10, at least one of Examples 5-9 further includes receiving, by a data quality score operator, a data quality score, and providing, by the GUI, the data quality score in guiding the user through the data acquisition.

Example 11 includes a non-transitory machine-readable medium including instructions that, when executed by a machine, cause the machine to perform the method of one of Examples 1-10.

Example 12 includes a system comprising processing circuitry, a GUI, and a memory including instructions that, when executed by the processing circuitry, cause the processing circuitry to perform operations comprising the method of one of Examples 1-10.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instance or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, by a graphical user interface (GUI), for data analytics and machine learning (ML) model project deployment, the method comprising:
providing, on the GUI, a first graphical software control that causes a project creation wizard to be presented on the GUI;
providing, on the GUI, a second graphical software control that causes previously generated projects to be presented on the GUI;
providing, on the GUI, a third graphical software control that causes previously generated models to be presented on the GUI; and
providing, on the GUI, a fourth graphical software control that causes a marketplace of data science projects to be presented on the GUI.

2. The method of claim 1, further comprising:
providing, on the GUI and concurrently with the first, second, third, and fourth graphical software controls, a selectable list of the previously generated projects.

3. The method of claim 1, further comprising:
providing, on the GUI and concurrently with the first, second, third, and fourth graphical software controls, a selectable list of the previously generated models.

4. The method of claim 1, further comprising:
providing, on the GUI and concurrently with the first, second, third, and fourth graphical software controls, a watchlist of models, projects, and deployments that a user has previously indicated is to be included on the watchlist.

5. The method of claim 1, wherein the wizard configures the GUI in a series of consecutive states that guides a user through data acquisition, model generation, and deployment of the model or a widget to the marketplace.

6. The method of claim 5, wherein the series of consecutive states further guides the user through data cleansing.

7. The method of claim 5, wherein the series of consecutive states further guides the user through data transformation.

8. The method of claim 5, further comprising:
receiving, by a model recommender that compares a representation of a project objective, project description, and tags of a model being generated to corresponding descriptions of previously generated models, a list of recommended models; and
providing, by the GUI, the list of recommended models in guiding the user through model generation.

9. The method of claim 5, further comprising:
receiving, by a visual analytics recommender that compares a representation of a project objective, project description, and tags of a deployment being generated to corresponding descriptions of previously generated deployments, a list of recommended deployments; and
providing, by the GUI, the list of recommended deployments in guiding the user through the deployment of the model.

10. The method of claim 5, further comprising:
receiving, by a data quality score operator, a data quality score; and
providing, by the GUI, the data quality score in guiding the user through the data acquisition.

11. A non-transitory machine-readable medium including instructions that, when executed by a machine, cause the machine to perform operations for data analytics and machine learning (ML) model project deployment by a graphical user interface (GUI), the operations comprising:
providing, on the GUI, a first graphical software control that causes a project creation wizard to be presented on the GUI;
providing, on the GUI, a second graphical software control that causes previously generated projects to be presented on the GUI;
providing, on the GUI, a third graphical software control that causes previously generated models to be presented on the GUI; and
providing, on the GUI, a fourth graphical software control that causes a marketplace of data science projects to be presented on the GUI.

12. The machine-readable medium of claim 11, wherein the operations further comprise:
providing, on the GUI and concurrently with the first, second, third, and fourth graphical software controls, a selectable list of the previously generated projects.

13. The machine-readable medium of claim 11, wherein the operations further comprise:
providing, on the GUI and concurrently with the first, second, third, and fourth graphical software controls, a selectable list of the previously generated models.

14. The machine-readable medium of claim 11, wherein the operations further comprise:
providing, on the GUI and concurrently with the first, second, third, and fourth graphical software controls, a watchlist of models, projects, and deployments that a user has previously indicated is to be included on the watchlist.

15. The machine-readable medium of claim 11, wherein the wizard configures the GUI in a series of consecutive states that guides a user through data acquisition, model generation, and deployment of the model or a widget to the marketplace.

16. A system for data analytics and machine learning (ML) model project deployment, the system comprising:
processing circuitry;
a graphical user interface (GUI);
a memory including instructions that, when executed by the processing circuitry, cause the processing circuitry to perform operations comprising:
providing, on the GUI, a first graphical software control that causes a project creation wizard to be presented on the GUI;
providing, on the GUI, a second graphical software control that causes previously generated projects to be presented on the GUI;
providing, on the GUI, a third graphical software control that causes previously generated models to be presented on the GUI; and
providing, on the GUI, a fourth graphical software control that causes a marketplace of data science projects to be presented on the GUI.

17. The system of claim 16, wherein:
the wizard configures the GUI in a series of consecutive states that guides a user through data acquisition, model or project generation, and deployment of the model, project, or a widget to the marketplace; and
wherein the series of consecutive states further guides the user through data cleansing.

18. The system of claim 17, wherein the series of consecutive states further guides the user through data transformation.

19. The system of claim 16, wherein the operations further comprise:
receiving, by a model recommender that compares a representation of a project objective, project description, and tags of a model being generated to corresponding descriptions of previously generated models, a list of recommended models; and
providing, by the GUI, the list of recommended models in guiding the user through model generation.

20. The system of claim 16, wherein the operations further comprise:
receiving, by a visual analytics recommender that compares a representation of a project objective, project description, and tags of a deployment being generated to corresponding descriptions of previously generated deployments, a list of recommended deployments; and
providing, by the GUI, the list of recommended deployments in guiding the user through the deployment of the model.
